(19) United States
(12) Patent Application Publication
(10) Pub. No.: US 2007/0031282 A1
(43) Pub. Date: Feb. 8, 2007

(54) Devices and methods for interfacing microfluidic devices with fluid handling devices

(76) Inventors: Piero Zucchelli, Versonnex (FR); Tilo Callenbach, Jona (CH); Gian-Luca Lettieri, Neuchatel (CH); Helmut Mett, Neuenburg (DE); Isabelle Semac, Geneva (CH); Bart Van de Vyver, Geneva (CH); Herve Wioland, Saint Genis-Pouilly (FR)

Correspondence Address: John C. Serio;Brown Rudnick Berlack Israels LLP, One Financial Center, Box IP, Boston, MA, 02111, US

(21) Appl. No.: 11/331,653

(22) Filed: Jan. 13, 2006

(30) Foreign Application Priority Data
Aug. 4, 2005 (WO) PCT/US05/27867

(51) Int. Cl. G01N 31/22

(52) U.S. Cl. 422/57

(57) ABSTRACT

The present invention is directed generally to devices and methods with the purpose of interfacing microfluidic devices with dispensing and fluid handling systems. Specifically, the present invention consists in the design of the inlets of a microfluidic device in such a way that multiple units can be loaded as a single compact device, with a unitary interface format which is compatible with existing industry standards.

### CROSS REFERENCE TO RELATED APPLICATIONS

This application claims priority from U.S. Provisional Patent Application Ser. No. 60/598,598 filed on Aug. 4, 2004 and PCT US2005/027867 filed on Aug. 4, 2005, the contents of both are incorporated herein by reference in their entirety.

### FIELD OF THE INVENTION

The present invention relates to the field of microfluidic circuits for chemical, biological, and biochemical processes or reactions. More specifically, it discloses devices and methods for interfacing microfluidic devices with fluid handling devices.

### BACKGROUND OF THE INVENTION

In recent years, the pharmaceutical, biotechnology, chemical and related industries have increasingly adopted devices containing micro-chambers and channel structures for performing various reactions and analyses. These devices, commonly referred to as microfluidic devices, allow a reduction in volume of the reagents and sample required to perform an assay. They also enable a large number of reactions without human intervention, either in parallel or in serially, in a very predictable and reproducible way. Microfluidic devices are therefore promising devices to realize a Micro Total Analysis System (micro-TAS), definition that characterizes miniaturized devices that have the functionality of a conventional laboratory.

In general, all attempts at micro-TAS devices can be characterized in two ways: according to the forces responsible for the fluid transport and according to the mechanism used to direct the flow of fluids. The former are referred to as motors. The latter are referred to as valves, and constitute logic or analogue actuators, essential for a number of basic operations such as volumetric quantitation of fluids, mixing of fluids, connecting a set of fluid inlets to a set of fluid outputs, sealing containers (to gas or to liquids passage according to the application) in a sufficiently tight manner to allow fluid storage, regulating the fluid flow speed. A combination of valves and motors on a microfluidic network, complemented by input means to load the devices, and readout means to measure the outcome of the analysis, make a micro-TAS possible and useful. With increasing performances and miniaturization of the devices, the need for a reliable and adaptable interface to the macroscopic world becomes a requirement to allow users to exploit the functionality of these systems, both for research and commercial applications.

It is evident that most reagents today are stocked in formats not specifically designed for microfluidics, and these formats are heterogeneous: for example, vials and tubes in the diagnostics area and in the academic world, micro-plates in the drugs discovery industry. The existence of standards (for example, the Society of Biomolecular screening has defined an open standard for micro-plates) has stimulated many years of commercialization of a large number of fluid handling tools specifically designed for the common standardized formats. The availability of a large installed base of instruments makes the introduction of products not compliant to the fluid storage standards difficult, for reasons related to laboratory space availability, maintenance, costs and user habits.

Fluid handling devices, also called fluid handlers, dispensing devices, sample loading robots, compound dispensers, dispensing means, pipettors, pipette workstations, have the purpose of transferring fluids, and in particular liquids, from fluid storage to further fluid storage. The components that take part in a typical fluid handling process can therefore be classified into three categories, according to their role in the process: (i) the source of the original fluid storage, (ii) the means by which the fluid is transferred, and (iii) the container in the fluid storage where the fluid is moved to.

In general terms, an automated dispensing device is not always strictly needed, since the dispensing operation could be performed by a human operator equipped with specific tools, like pipettors or similar devices. However, all dispensing devices can be described according to their overall characteristics, like for example operational speed, performance, cost, contamination issues and versatility. The desired requirements of fluid handling devices are the highest speed possible (to achieve high productivity, but also to allow to perform assays in similar conditions like temperature, reagents activity, etc.), minimal contamination between sources and containers, minimal fixed cost and minimal cost per dispensing operation (consumables), performances (precision of dosing, range of volumes that can be dispensed, footprint, etc.) and versatility (multi-format compatibility, type of operations performed, automatic identification of source and container, etc.).

All existing fluid handling devices address or partially solve these requirements, and the user choice depends on the specific application and on the laboratory environment. Being the environments heterogeneous, the dispensing instruments—exactly as it is for the fluid storage means—differ significantly and adopt different technologies: disposable tips and suction means, metallic pins immerged in the fluids, aspirating needles and subsequent rinsing and cleaning operations, pumps and tubing, ejection of droplets by piezoelectric or other mechanical means. Also the infrastructure surrounding the dispensing technology and its degree of automation differ enormously, going from complex installations for compound libraries management in the pharmaceutical industry, to simple hand-held devices.

Microfluidic devices deal with volumes that are typically negligible in the standard assay environment, so they usually take part to the process in the form of the dispensing devices or in the form of containers; in fact it is improbable to move microscopic volumes of fluids into macroscopic containers, since detection methods used in the subsequent step of an assay could miss sensitivity, or because the reaction would simply require larger amounts of samples. An example of microfluidic dispensing device is a piezoelectric nozzle. An example of microfluidic container is a microarray for genetic analysis. It should be noted, however, that “microscale-to-microscale device” fluid transfers will become very important as soon as a larger number of assays will be performed in microfluidic formats; in that case, microfluidic devices will take part to the process also as sources.

Centripetal devices are a specific class of microfluidic devices, where the micro-fluidic devices are spun around a rotation axis in such a way that the centripetal acceleration generates an apparent centrifugal force on the microfluidic device itself, and on any fluid contained within the microfluidic device. The centrifugal force acts as a motor, in the radial but also in the tangential direction if the angular momentum varies. This force, however, is applied at the same time to any material contained in the microfluidic device, including the fluids that are contained in the inlets. In most centripetal microfluidic devices, like for example those developed by Gyros AB, Tecan AG, Burstein Technologies Inc. for example, micro-fluidic devices have the shape of disks, and the rotation axis is perpendicular to the main faces and passing through the centre of the disk. The centrifugal force, therefore, is also parallel to the surface of the disk: it is evident that non-sealed inputs manufactured on the surface require a very specific shape in order to prevent overspill of the fluid out of the inlet aperture.

A possible geometrical shape for an inlet in these devices is a cone with its apex cut off by a plane parallel to its base, also known as frustum, where the inlet aperture is located on the top of the truncated cone. When the centrifugal force on the fluid contained in the inlet exceeds the gravity and the surface tension forces, the only usable volume of the input reservoir is the fraction of volume characterized by radii which are larger than the largest radius of the inlet aperture. This clearly limits the capacity of the inlet to a fraction of the actual reservoir volume, and cannot prevent undesired overspill if the fluid is dispensed in excess to this fraction (for example, because of the limited dispensing accuracy of a fluid dispensing system when dealing with small volumes).

In addition, it should be known that various technologies, for example injection moulding, put constraints in the geometrical shape of the inlet. In injection moulding the replicated device has to be extracted from the mould that determined its shape, and this operation becomes impossible if the previously mentioned inlet with a truncated cone shape is attached to the mould structure by the top. It should be also noted that for volumes typical of microfluidic devices the surface tension value characteristic of most fluids prevents them to flow out of the device when the inputs are not vertical, so that the microfluidic device can be kept at rest—with any orientation in space (and, for example, horizontally). This phenomenon remains valid when the microfluidic device is subject to small acceleration, or for those accelerations having appropriate direction.

The challenge of interfacing microfluidic devices in first instance is the problem of loading fluids from a conventional source (e.g. vial, micro-titre plate or an Eppendorf tube) into a microfluidic device. This interfacing challenge has been typically addressed in the past by the engineering of specific, proprietary dispensing devices customized to a given microfluidic device, or the design of a suitable “macroscale-to-microscale interface”. This interface allows the efficient use of existing infrastructures and fluid loading facilities by extending their applicability into the micro-scale world. While this approach has the advantage of reducing switching costs by using existing infrastructure, it often limits the advantages consequent to the miniaturization effort (e.g. small reagent consumption, density of data-points for a given substrate, etc.).

However, when a macroscopic interface is implemented onto a miniaturized device it is common that a large active area is sacrificially dedicated to the inputs and to the spacing in between. This input area, being implemented on a device manufactured with advanced high-resolution replication technologies, has a significant production cost and reduces the active space on a fixed micro-structured master size (typically a disk with 4, 6 or 8 inches diameter). Unfortunately, there is a significant manufacturing cost increase due to the presence of inputs organized according the mentioned interface. In addition, a large disk diameter should preferably remain inside the standard micro-plate footprint, to avoid the problem of disk manipulation in conventional micro-titre plate handlers or the requirement of substantial modifications to the software or to the hardware of existing handling systems. The same limitation on the maximum disk diameter is evident when the micro-device has to be used inside instruments designed for the micro-plate formats, like for example fluorescence and absorbance readers, incubators, imaging devices, centrifuges, shakers, barcode labellers, etc.

An additional limitation of current approaches is that a majority of microfluidic devices are designed and manufactured according to a two-dimensional process that generates pseudo three-dimensional structures. The two dimensional network is transformed into a three-dimensional micro-structured layer by means of etching, or sometimes extrusion, of a substrate at a depth identical for all components (or for a fraction of them) contained in the network. Because of this, most microfluidic networks are substantially planar or made by multi-layers with a planar conformation.

These characteristics are typical of lithographic processes, which are among the most common manufacturing techniques. Lithography requires masks, and each mask typically corresponds to a given etching depth on a planar substrate. Many other manufacturing processes have similar constraints: for example, laser ablation of a substrate has a limited etching depth and the microfluidic network is typically created onto a planar substrate. Also devices obtained by lamination, where different sheets are cut and laminated together, are essentially bi-dimensional. The same is valid for hot embossing where the microstructures are obtained by embossing a planar substrate onto a press and to the injection moulding technique. Injection moulding is probably the most important mass production technology: a master is etched—being in silicon, glass, SU8, peek or other material—and possibly replicated by electroplating into a metallic mould insert. The micro-structured insert is positioned in a cavity that gives shape to the high temperature polymer injected in the mould, and since the insert comes essentially from a lithographic procedure (or a substantially planar technology) the microstructures replicated in this way are also distributed on a plane.

A common problem in the production of microfluidic devices consists in the fact that inputs typically required to load the fluids in the devices have to be manufactured with a method different from the one used in the micro-structuring operation. This problem comes from the requirement that micro-fluidic devices have to be loaded from the outside; therefore inputs have to reach the external surface of the device. Input manufacturing often requires post-processing or a specific manufacturing technology. Examples of these processes are laser drilling of the substrate body, mechanical drilling, needle penetration through soft substrates and assembly of cover structures containing ports on top of the substrate containing the microstructures. Any additional procedure in the manufacturing process, however, is undesired since it implies significant manufacturing issues like cost increase, yield reduction, production rate decrease, dust contamination failures, relative alignment problems and process quality control.

The injection moulding process, in particular, is a common method of fabricating plastic devices. As it is known in the art, media storage devices can be produced cheaply because of mass production scale considerations, but also because they have no passing-through connections, and all fine resolution structures, the pits where data is encoded, can be replicated in a single step of microlithography. As soon as passing-through structures are required, the moulds for manufacturing become more complicated and the mould cycle time becomes longer thereby increasing production cost. For example, passing-through connections could require the addition of other mould inserts that should match and connect exactly to the insert replicating the microstructures on the device. A fluidic connection between parts of a device formed by two different inserts implies a very critical matching of the position of the inserts, and also any possible gap in the connection between the two inserts will be filled by the fluid polymer at injection, a phenomenon that can potentially interrupt the fluidic connection in the replicated piece.

As it is the case for injection moulding, other production technologies are challenged by the requirement of manufacturing effectively and reliably input ports for microfluidic devices. As a last example, simple mechanical drilling of input ports is also critical because of the creation of dust and polymer residues, which could possibly fill the capillary entrance and therefore prevent the future passage of fluids.

The planar structure of the microfluidic network de-facto influences and determines the overall geometry of the body structure of a microfluidic device. Being all microstructures are on a two-dimensional plane, most substrates are substantially planar polyhedrons, characterized by having two faces with a large surface area (substantially larger than the other faces) and both faces are substantially parallel to the plane where the microstructures are located. These faces are to be the “main faces” of the polyhedron, and all the remaining faces are called “small faces.”

It is understood that all geometries where the faces, in particular the small faces, are not planar can be reconnected to this concept, for example by finite elements segmentation. As an example, the lateral surface of a disk (a cylinder with a small height) constitutes a non-planar surface, but the same surface could be represented by a large number of small faces with rectangular shape and therefore it is here considered as the small face of the disk. In addition, also extensions of the small faces extruding out of the space confined between the planes defined by the main faces, are here considered small faces (or part of small faces) in all respects.

Following these considerations, it is apparent that most microfluidic devices have a substantially planar structure, meaning with “planar” that the microstructures are positioned on one or a plurality of surfaces in space. Hereafter, the microfluidic devices with a substantially planar structure are also referred to as “tiles”.

Various attempts to address the problems above are exemplified by patents such as U.S. Pat. No. 6,251,343 by Caliper Life Sciences, Inc., which discloses an interface technology where the inputs of the microfluidic circuit are created by means of an additional cover, mounted on top of the device, comprising a plurality of apertures. The cover plate is mated to the ports of the body structure which is in fluidic communication with the microfluidic network, and the apertures allow dispensing of fluids and application of electrical connections with the fluids contained herein.

This solution relies on bonding quality of the body structure with the cover, and has the advantage that the cover manufacturing does not require the same replication quality required in the manufacturing of a microfluidic device—therefore it has a lower cost (but at the expense of an additional production step). Moreover, this solution is designed for electrophoresis where the input ports are loaded with significant amount of fluids, in order to guarantee the filling of capillaries and to allow electrodes to come into electrical contact with the fluid in the capillaries. The use of this interface is much less obvious for those devices and technologies requiring very low amount of fluids, for example at the micro-litre or sub-micro-litre level, since the collection of minute quantities of fluids at the interface between the cover and the chip is more critical, happening across a joint between different parts.

In a further approach, WO 00/78456 by Aclara Biosciences, Inc. describes a microfluidic device whose interface is planar and manufactured on top of a microstructure layer. The interface is designed in such a way to be compliant with the well-to-well spacing of a standard 96 or 384 micro-titre plate, which is standard within discovery labs within the pharmaceutical industry. Using this approach, one single chip can be loaded from a standard dispensing system as if it would be one single micro-titre plate. The operation of loading a plurality of microfluidic devices therefore becomes the repetition of the single-device loading procedure a plurality of times, and the loading time is therefore proportional to the number of devices to be loaded.

Another approach is disclosed in WO 02/055197 by Evotec OAI AG. In this disclosure, a sample carrier is disclosed where micro-reactions happen in wells equivalent to the standard micro-titre plate, but characterized by a significant reduction of assay volumes. This reduction is made possible by specific devices to prevent evaporation, that include the tight sealing of the wells by lidding the device with a hard cover, complemented by specific dispensing devices optimized for low volumes dispensing and readout means designed for this format. It should be emphasized, however that in order to simplify the loading operations, Evotec also commercializes devices that are compatible with the standard 1536/384/96 micro-titre plate formats.

This approach substantially emulates the current mechanism of fluid handling and containers, by specifically addressing the limitations (evaporation and dispensing accuracy among others) by customised approaches. In particular, to fully exploit the reaction miniaturization, the dispensing accuracy has to be increased according to the volume reduction, and Evotec therefore commercialises custom dispensing devices with increased performances to substitute the conventional systems used in the industry, that possibly constitutes a barrier for adoption.

These custom devices require dispensing heads substantially different from conventional pipetting system, going for example from technologies where the dispensing head is disposable (plastic tip) to technologies where the dispensing head is not disposable. Differently from the domain of inkjet printing, where the fluid contained in a dispensing head doesn't change during the head lifetime, here the fluids are continuously substituted, and they have very different chemical properties. It is of the uttermost importance to avoid any possible contamination, and the use of a non-disposable dispensing head therefore constitutes a limitation requiring cleaning and quality check of the cleaning procedure, if not head replacement with a significant operational cost increase.

A further approach is disclosed in WO 01/87475 by TECAN AG. This disclosure describes the implementation of an interface meant to adapt a centripetal microfluidic disk to a conventional robotized fluid handling system. This is achieved by manufacturing, in the region internal to the area occupied by the microfluidic structures, 48 input wells with an interspacing pitch corresponding to the 384 and 96 well-plate standards for columns and rows respectively. Using this approach one-half of a micro-titre plate could be transferred to a single microfluidic device, and the device could be loaded with conventional fluid handling devices. Unfortunately, the surface occupied by the interface cannot be used for additional microstructures since fluids move radially outwards, and therefore fluids in the inputs could not reach microstructures at smaller radii than the inputs themselves.

Another approach to interfacing fluid handling devices is shown in U.S. Pat. Nos. 6,620,625 and 6,149,787 to Caliper Life Sciences, Inc. These disclosures recognize the need of a high-throughput interface for microfluidic devices for compound sampling in drug discovery screening. The Caliper approach addresses this challenge by means of capillary forces generated by immersing a capillary into a liquid (sipping). According to this interface, the fluid transfer is achieved by first dipping one end of a capillary, integral part of the microfluidic circuit, into the fluid source and subsequent filling of the capillary. Limitations of the technology consist in the difficulty of sampling different volumes of fluids, for example required when the reagents have different concentrations. Using this technology large volumes are impossible to transfer in one operation since the surface tension forces would not overcome the gravitational force. A further limitation of this interfacing technology consists in the problem of contamination. The sipping operation implies that residues of the previously sipped compound can be possibly transferred to the next well, therefore damaging the source integrity.

Yet another approach is disclosed in U.S. Pat. No. 6,090,251 to Caliper Life Sciences, Inc. This patent discloses a custom micro-structured plate for dispensing fluids into a microfluidic device. The interface is designed in order to minimize fluid losses, and is optimised for the transfer of minute quantities of fluids in parallel. While this solution improves the throughput of the loading operation, it is essentially limited in the versatility since the involved volumes are not arbitrary and depend on the geometry of the plate and on the characteristics of the fluids involved, for example the surface tension properties.

A further approach is disclosed in WO 03/035538 by Gyros AB. This disclosure describes an interface suitable to centripetal systems, where the requirement of high throughput dispensing is achieved by dispensing droplets at high repetition rates in a fixed position, where at the same time the microfluidic device rotates below the dispenser. This microfluidic device presents inputs at constant radius but at different angular positions. By synchronization of the droplet ejection with the disk motion, the drops arrive into the right receptacles present in the disk. This interface technology optimizes transfer speed and metering accuracy for small volumes of fluids, at the price of a loading facility which is custom designed for this specific microfluidic device. Unfortunately, a limitation of this dispensing technology consists in the contamination of the drop ejecting head, which comes in contact with the fluid by means of a non-consumable component. To avoid contamination, it has to be accurately rinsed before being reused in the next dispensing operation with a different liquid.

Another approach is disclosed in WO 00/78456 to Orchid Biosciences, Inc. This disclosure is an original implementation of a microfluidic device interface, since the fluidic connections are more inspired to the electronic industry than to the biochemistry traditions. The chips are connected by fluid-tight sockets to external tubing, and the liquids flow into the microfluidic device as consequence of pressure applied to the tubes by external actuators. The complexity of the connections makes this solution improbable for high-throughput liquid loading, since each chip has to be fully connected to the loading device before being used. Tubing contamination is a major challenge, and its systematic replacement would imply a significant amount of consumables cost and additional logistics.

A manufacturing method of producing micro-fluidic devices is disclosed in M. A. Gretillat et al. (Sensors and actuators A 60 (1997) 219-222). This article discloses a manufacturing method for the realization of inputs on a Pyrex microfluidic device, which is manufactured according to a multilayer and multi-substrates structure. The microfluidic components, thin capillaries, are manufactured on one layer and communicate with a second layer of structures with larger dimensions, the inlets, through connection holes. The inlets reach the border of the device, and fluid loading is possible by means of needles to be inserted in the bore. In this design, inlets and microstructures sit on two different layers which are manufactured with the same technology but independently. The manufacturing of the overall device requires structuring of three different planar substrates, one of which is etched on both surfaces and shared between the layers, for a total of four different micro-structuring steps.

### SUMMARY OF THE INVENTION

In the current inventive device and method, a plurality of micro-fluidic devices or tiles are assembled in a three-dimensional structure while maintaining a two-dimensional interface format. This assembly allows fast and efficient loading operations of these micro-fluidic tiles. According to the invention, a plurality of tiles can be loaded in parallel as if they would be a single conventional micro-titre well plate, and not in sequence as done by most existing implementations. In addition, these multi dimensional characteristics of the inventive microfluidic tiles can be achieved by loading them by means of conventional standard liquid handler devices. The inventive three dimensional assembly can be permanent, or preferentially made to allow the detachment of the individual tiles, or a subset of the tiles, for other operations including loading, assay processing, readout of the assay, disposal of the fluids or partial processing of the assembly.

For the purpose of this disclosure no distinction is made between inputs, inlets, outlets, ports, connections, wells, reservoirs and similar words, all referring to the means by which fluids can enter, or exit, from the microfluidic network.

According to the invention, ports are not located on the planar faces of the substrate, as in prior approaches, but are located on one or a plurality of small faces. In one illustrative embodiment the inputs sit in the same plane of the microfluidic structures. This makes possible the manufacturing of ports with the same manufacturing technology used for replicating the microstructures. Typically, ports will sit in-between, adjacent or nearby to the interface cover-substrate or substrate-substrate; this interface is often present in planar microfluidic devices, where open-roof structures are created onto a planar surface and an additional substrate closes the roof to guarantee fluid tightness. Cover and substrates can either have a symmetrical role, for example similar dimensions and presence of microstructures in both, but also could substantially differ in size, footprint, thickness, dimensions and manufacturing process.

A class of devices manufactured according to the invention, is the one consisting of a sandwich of substrates which are simply connected, and have input ports accessible from the outside of the sandwich. A geometrical object is called simply connected if it consists of one piece and doesn't have any circle-shaped “holes” or “handles”. For instance, a doughnut (with hole) is not simply connected, but a ball (even a hollow one) is. A circle is not simply connected but a disk and a line are. In a simply connected substrate it is possible to take a piece of string and position a first end of the string onto the substrate at any point. When the second end of the string is allowed to follow any arbitrary path and it is connected again with the first end, the string forms a loop. If it is always possible to detach the loop from the substrate without cutting the string or the substrate, the substrate is simply connected. In other words, if there is any path that makes it impossible to get the loop of string out, the substrate is not simply connected. If no path from any point of entry gets the loop caught in the substrate, then it is simply connected.

Advantageously, with respect to the present passing-through solution with inputs on the main faces as mentioned, the inventive devices and methods allows using a homogeneous manufacturing method for ports and microstructures, which minimizes replication costs and post-processing operations. Many production processes can allow the input ports on small faces to be produced at the same time that the microfluidic structures are produced. This reduces the cost of production processes and improves related quality control.

According to the invention, production methods such as hot embossing can take advantage of inputs manufactured on the small faces. The hot embossing technique relies on the change of properties of polymers and similar materials, which form substrates according to the invention, when their temperature is increased. The softening of the material, aided by application of pressure on the surface, allows modifying the morphology of the surface of the substrate with the purpose of replicating microstructures. In one illustrative embodiment of the invention, inlets can be manufactured by means of the same process, without requiring any modification to the deep part of the substrate that would be more difficult to achieve and would also imply the displacement of large volumes of material, with subsequent deformation of the sample. The inputs can therefore be designed directly in the master containing the microfluidic structures, so as to replicate the microfluidic components and the inlets in a single production step.

In a further illustrative embodiment, production of the inventive tile by injection moulding advantageously allows ports on the small faces. In fact, passing-through inlets require the presence of deep structures in the mould, and their design is critical both in relation with the connections with the microfluidic structures, as explained earlier, and in connection to the filling behaviour of the fluid polymer during injection. The injected flow in particular should allow the polymer to reach all empty parts of the cavity, with limited pressure drop and temperature decrease, and this becomes more difficult when extruding structures are present on the path. Typically, structures with low aspect ratio and positioned on the outer surface of the replicated part are preferable, as in the case of side inputs design, therefore side ports are a desirable solution for devices replicated by injection moulding.

In a further illustrative embodiment, inputs on the small faces constitute an advantage also for the production of silicon microfluidic devices, because there is no need to penetrate deeply into the silicon structure. Since silicon is a hard material with crystalline structure, it is brittle and difficult to machine with mechanical means. Passing-through inputs are preferably generated by chemical etching, which requires a long and aggressive erosion of the material that implies particular care in the control of shape and vertical profile of the inlets. With inputs on the small faces, the penetration of the process can be limited to the skin of the substrate, independently of the ports volume and shape that can be adjusted by the design of the planar lithographic masks. The etching process is therefore more reliable and the time for etching advantageously reduced.

In a further illustrative embodiment, laser ablation is often used for the production of microfluidic devices. In this production method, a laser beam removes desired material, by ultra-violet irradiation of a polymer and therefore produces a small pit that can be moved over the substrate to design an actual microfluidic structure. With this method, the realization of a passing-through input as in prior art approaches would require an unpractical amount of time, or additional processing. However, in the case of inputs on the small faces, ports can be manufactured on the skin of the substrate.

In the case of traditional main face inputs, which require a thick substrate or a design where the liquid containing cavity is larger than the input. The use of a larger cavity, however, produces bubbles that prevent an easy filling of the port, which is hardly ergonomic for loading. The interface design, according to the invention, allows for a large variety of input geometries, both concerning the shape of the opening and the longitudinal shape of the reservoir governing the fluid collection. In particular, ports located on the small faces according to the invention can be built in two halves, each of which belongs to different substrates. The port can be symmetric, for example half on one substrate and half on the other substrate of the sandwich, but it could also asymmetric, and for example completely on one substrate.

The shape of the inventive input opening can be in the form of any geometric shape including but not limited to a square or hexagonal shaped input. The inventive input can be manufactured by hot embossing or injection moulding or by means of joining two substrates symmetrically embossed with a rectangular or trapezoidal master. The longitudinal shape of the input can be essentially chosen according to the need. It is contemplated within the scope of the invention that cones, inverted cones or “expansion chambers” become feasible, that would be otherwise very expensive to manufacture in the case of passing-through ports located on main faces.

Another advantage of inputs on the small faces according to the invention is related to the optical integrity of the main face surface. According to the invention, the main face of the microfluidic tile has no additional structures on its outer surface. This advantage allows microfluidic structures contained inside the device to be optically accessible from the outside through a homogeneous, planar, optical grade substrate surface. This aspect of the present invention is particularly relevant for most optical readout means, like for example microscopes, confocal imagers, surface plasmon resonance readers, fluorescence readers, absorbance readers, light scattering measurement devices, polarization sensitive light detectors, but also for devices irradiating the samples or the microfluidic devices with light beams, for example the microfluidic device disclosed in the international patent application WO04050242A2, which is incorporated in its entirety by reference.

It is contemplated within the scope of the invention to have a microfluidic device with side inputs inserted directly or by means of adaptors in a conventional micro-plate reader, which is optically accessing the microfluidic reactors from the substantially flat surface of one of the main faces, or both. This configuration does not compromise the optical readout of the samples, which are optimally accessed through a planar window. Equivalent optical solutions having the ports still on the main faces, but displaced from the microfluidic structures, are less efficient in terms of manufacturing costs, since the same device would occupy a larger surface.

In addition to the minimal modification to the production method, side inputs do not typically require modifications to materials used in the manufacturing process of the microfluidic device, being essentially the same manufacturing process adopted for the replication of the microfluidic structures in the device. For example, most polymers used in injection moulding, like COC, COP, PC, PMMA, PS, and similar are all suitable for injection moulding production of side inputs, and devices with side inputs and different manufacturing methods can be made in most of the materials used today like PDMS, glass, photosensitive substrates, silicon, metals semiconductors and crystals.

Other advantages of the interface of the present invention become more evident when complemented with specific microfluidic technologies, like the one disclosed in the international patent application WO04050242A2. In this case, the requirement of accurate dosing of minute quantities of fluids, which is typically difficult with conventional dispensing systems, is achieved by complementing the dispensing device functionality with precision metering of the fluids inside the microfluidic device.

The present invention advantageously allows the use of existing dispensing solutions designed for the macroscopic world by extending and expanding their use with microfluidic devices without the need of additional instruments. For example, from the user point of view the metering accuracy of the existing dispensing device is virtually extended to the microfluidics, and enhanced for small volumes dispensing. On the other hand, there is still the possibility of dispensing large volumes into the microfluidic device, which is sometimes necessary for the distribution of buffer liquids. The dynamic range of the dispensing operation is therefore increased, and allows more flexible operations with respect to solutions specifically designed for microfluidics.

A further advantage of the present invention relates to the loading process, and in particular when the performances of the microfluidic devices imply high-throughput (or high efficiency) loading. High-throughput loading is a challenging process that requires optimization of various methods and device performances, for example the fluid dispensing action and the related operations, like tip disposal or needle cleaning for example, but also the robotized handling of the microfluidic devices, that determines the time needed to replace a device on the fluid handler apparatus with a new unit. These operations, in particular in drug discovery, often require the use of automation, not only for reasons of speed, but also for reasons of reliability and reproducibility.

The performances of a conventional fluid handling station, therefore, can be optimized along various directions: first, by performing more assays on average for unitary operation of the fluid handling station, i.e. the loading process. This is typically the objective of most microfluidic devices that integrate readout and different degrees of sample preparation and metering inside the device itself. Second, by designing the microfluidic devices and their interfaces in order to interact only at the beginning or at the end of the assay process with the fluid handling system, and allowing the reagents to be stored on the microfluidic chip for the duration of the assay, in order not to require external dispensing operations during the assay protocol. Third, by reducing the dead-time generated by the replacement of the microfluidic devices on the fluid handling system and its related logistics.

According to the invention, parallel loading of a plurality of microfluidic devices is performed in a single fluid handling operation. In fact, conventional fluid handling robots spend a large fraction of time, and also the largest part of consumables cost, in the operation of cleaning the dispensing head (or in its replacement), and in the operation of loading the right fluid into the dispensing system. Therefore, loading more than one device in parallel by single or multiple dispensing allows a faster throughput and a reduction in consumables cost.

It is an object of the invention that a plurality of microfluidic devices are collectively organized in a space having a suitable format that presents to the fluid handling device a unitary interface. The interface, possibly compatible with existing standards, exploits advantageously the presence of inputs on the small faces of the microfluidic devices, in order to assemble the tiles in a compact object, hereby referred to as a “brick”. The tiles can be kept together in the brick by mechanical solutions, like pins, enclosures, slits, slots, locks, covers, snap-in elements, spacers, “lego-like” connectors, elastic means but also by the use of adhesive layers, magnetic means, or the like.

It is contemplated within the scope of the invention, that the brick can comprise additional structures, such as a frame, or could be assembled by simply connecting the tiles together in a frameless format. The frame can be designed in order to reproduce the loading features of a standard micro-titre plate, but could also be designed in order to minimize, for example, dust contamination of the inlets. The frame can have additional functional roles, like tile ejection means or a collapsible structure for tile extraction, or thermal insulation, heating and cooling capabilities.

The frame could also be inspired to the structures used in the manipulation of silicon wafers in the electronic industry, for example as described in patents U.S. Pat. No. 4,248,346 and U.S. Pat. No. 5,125,524, which are incorporated by reference in their entirety, or to the structures used in the optical media industry for storage of data. It is contemplated within the scope of the invention that the frame can act as a shipping support, protecting the tiles as if they would be within a package, or could be simply an alignment mean in order to facilitate the loading of liquids with conventional fluid handling devices.

The assembly and disassembly of the brick into its constituent tiles, or the addition of one or more tiles to the brick as well as the removal of one or more tiles from the brick, can be achieved in different ways and these operations, individually or collectively, are here referred to as packing operations. In some illustrative embodiments the frame could act as a tile holder, and the tile position is defined by the frame. In other illustrative embodiments, the tile position can be defined by the neighbouring tiles, or by other tiles in the brick. In some cases individual tiles could be packed individually, or could be accessible by a “first-in first-out” or a “first-in last-out” packing approach.

The tiles can be packed in a brick by means of a “top face” insertion, where the top face of the brick is defined as the face constituted by the assembly of tile faces presenting the inputs, but also by packing the tiles from the bottom or by one or more of the lateral faces of the brick. It is also understood that independently of the presence of the frame the face of the brick where liquids enter and exit does not correspond necessarily to the faces where the tiles enter or exit for the packing operations.

It is contemplated within the scope of the invention that the brick fluids can be loaded at the beginning of the assay, minimizing the time occupation of the fluid handling system and at the same time the use of dispensing consumables like tips. The brick can afterwards be disassembled into its constituents tiles, which are then processed independently or in parallel according to the user needs. The location of inputs on the small faces according to the invention allows for a compact, unitary interface for a plurality of devices.

In the brick assembly, the surface occupation is minimized since the main faces of the tiles are facing each other, while all inputs remain accessible. If the main faces are vertical, the tile occupation is done at the moderate expense of vertical occupation of the brick.

With particular microfluidic technologies such as disclosed in international application WO04050242A2, it is possible to exploit additionally the brick geometry since a large number of active reactors, and metering elements, can be manufactured on a tile. The inputs of the loading interface, therefore, are just entry ports that allow the fluids to access to a more complex fluidic logic that allows performing a plurality of assays in parallel, in a plurality of conditions.

The functionality of the brick is largely extended with respect to the functionality of a micro-titre plate, since the assays can be performed starting from raw reagents, without the need of pre-dilution or incubations, and all assays can be performed after the loading operation, without the need during the assay protocol of an external dispensing system. This possibility allows a significant improvement in throughput and logistics, since the loading process becomes the straightforward operation of providing to the brick the reagents required, and then the fluid handling instrument can be released for subsequent loading operations while the tiles from the loaded brick are being processed.

Another advantage of inputs on the small faces and of the brick design according to the invention is related to the intrinsic sensitivity of microfluidic devices to the presence of dust particles or residues in the microstructures that could potentially compromise their functionality. These particles can enter into the microstructures in various moments: during the manufacturing process, when the liquid is inserted in the microfluidic device, but also when the air around the inlets contains dust, which enters into the inputs before the liquid is loaded in the device. In the last case, the liquid transports the dust particles inside the microfluidic device, and clogging could occur when the size of the particles is similar to the size of the liquid passages.

A typical procedure to prevent the deposition of dust particles inside the inputs consists in the systematic protection of the inlets by application of seals, films, covers or similar means. This procedure is simpler, more effective and more economical when it is performed on the side inputs, since the number of sealed inputs per unit surface of the cover is larger in a tile with side inputs with respect to a tile with the same inputs on the main faces, and more tiles can be protected at the same time by one cover when they are assembled into a brick.

An additional advantage of the brick concept according to the invention consists in the possibility of sealing the brick as a single object, with the purpose to preserve the reagents loaded in the tiles from evaporating in the time lapse between the loading operation and the actual assay. This is important since the time-lapse between the loading and the processing steps does not affect the result of the assay, allowing for an optimal allocation and scheduling of the instrument and of the other resources involved. Sealing could be performed on the complete set of tiles in the brick, or on a partial set of tiles in the brick, as well as on the complete set of inputs of a tile in the brick or on a partial set of inputs of a tile in the brick, or on any combination of these solutions.

According to the invention, sealing consists in the deposition of a film on top of the brick input surface, composed by the tiles inputs. The sealing film can be a layer of polymer, metal or a combination of both. The film can be applied by means of additional pressure sensitive or heat sensitive adhesives, but also the film itself could present intrinsic adhesive properties. Heat sealing is one of the options most compatible with reagents, and it is used both for temporary sealing (peelable films that prevent evaporation) or permanent sealing (long term storage that guarantees the integrity of the sample, like in drugs packages). Other embodiments of sealing options comprise the use of films that can be pierced by needles or tips, allowing the passage of fluids during dispensing but preventing the passage of gas after the fluid dispensing has been performed as disclosed in U.S. Pat. No. 5,789,251. It is contemplated within the scope of the invention that the design of the side inputs could reproduce one or a plurality of rows (or columns) of a standard micro-titre plate, so that most of the existing sealing technologies for micro-titre plates can be used.

It is also contemplated within the scope of the invention that when a brick has been sealed, individual tiles can be separated and processed independently if required by cutting the film sealing the brick in the direction parallel to the main faces, therefore with the possibility of keeping the tile sealed after removal from the brick assembly.

The sealing of individual tiles becomes more important when complemented with specific microfluidic technologies, like the one disclosed in the international application WO04050242A2. With the valving technology described in this international application, the liquid contained in the sealed reservoir can be transferred into the microfluidic structures without requiring the opening of the seal. Therefore an individual tile, pre-loaded with reagents, can be processed directly without requiring the opening of the sealed reservoirs that could be therefore permanently sealed. In fact, the reservoir can be put in fluidic communication with the microfluidic circuit by the opening of two lines, one required for the liquid flow and the second one required for the passage of gas, typically air, to prevent the formation of an under pressure in the reservoir that would prevent the extraction of the liquid. With this method, tile pre-loading becomes possible and can also be applied to a subset of the inputs present in the tile.

Another advantage of assembling tiles into a brick according to the invention consists in the possibility of labelling the tiles, either individually, as a block, or both. It is contemplated within the scope of the invention that identification of the brick could follow the same common practice adopted for micro-plates, and individual tile labels could be readable by a user without the need of additional instrumentation for a simple and rapid sorting of the tiles in the brick. The same information can be used to know, when the assay is performed, which reagents have been loaded into the tile and which assay should be performed for that specific file.

Labelling can be achieved by optical, mechanical, magnetic or radio means, and the label readout could require an external instrument, or could also be possible by simple visual inspection. Examples of bar-coding implementations are mechanical modifications of the tiles or of the brick (punching or removal of tabs), colour of the tiles, graphical drawings for ordering the tiles (like for example diagonal lines or texts across many tiles), application of adhesive barcode labels, direct printing of labels onto the tiles by inkjet or thermal methods, application of substrates with magnetic properties, or insertion of radio emitters or transponders.

Optical label information could be encoded in one-dimensional or two-dimensional formats, the latter allowing for space savings. Optical barcodes could be preferentially applied on the small faces, in such a way that the labels are still accessible and visible when the tiles are assembled in the brick format. The optical barcodes could also be positioned on the same face where the side inputs are located, but also sideways or in alternative on the bottom or on extruding parts.

Another significant advantage of the inventive brick consists in the extremely compact format, where the number of assays per unit volume (or per unit surface) can be dramatically increased. This compact format is useful in applications requiring the storage of compounds for the pharmaceutical industry, and the mentioned advantages are further enhanced by the fact that compounds can be accessed on a brick basis but also by extraction of individual tiles.

### BRIEF DESCRIPTION OF THE DRAWINGS

These and other advantages, objects and features of the invention will be apparent through the detailed description of the embodiments and the drawings attached hereto. It is also to be understood that both the foregoing general description and the following detailed description are exemplary and not restrictive of the scope of the invention.

FIGS. 1A, 1B, 1C and 1D depict an embodiment of a rotor tile according to the invention, where the inlets are on the small side of the tile and the tile can be designed to fit into a brick;

FIG. 2 depicts a design for input interfaces according to the invention, optimized for injection moulding mass-production;

FIG. 3 illustrates another specific embodiment according to the invention where the side inputs can be manufactured so that microfluidic structures and inlets on the tiles are physically separated during the production of the substrate;

FIG. 4 depicts a single tile according to the invention that is partially sealed by application of a film that prevents the fluid evaporation;

FIGS. 5A, 6B and 5C depict a further illustrative embodiment having a format compatible with 1536 micro-plates, where only 768 of the inputs are actually implemented;

FIG. 6 depicts a tile and the related brick assembly according to the invention;

FIG. 7 depicts tips of a multi-head dispensing device, and loading of the tiles is performed as with a micro-titre plate;

FIG. 8 depicts a centripetal microfluidic system according to the invention, where the microfluidic tiles are subject to the centrifugal force by means of a spindle device allowing moving the fluids inside the microstructures;

FIG. 9 illustrates a further illustrative embodiment according to the invention, where a plurality of bricks is used in the loading operations with minor modifications with respect to the design of a single brick loader;

FIG. 10 illustrates a further illustrative embodiment according to the invention, where tiles within a brick are extracted from the bottom of the brick;

FIG. 11 illustrates a further illustrative embodiment according to the invention, where an automated extraction solution for tile removal is shown;

FIG. 12 illustrates a rotor adapted for receiving tiles according to the invention;

FIG. 13 illustrates a microfluidic tile according to the invention;

FIG. 14 illustrates a microfluidic tile according to the invention having alignment marks;

FIG. 15 illustrates a microfluidic tile according to the invention having alternative alignment marks;

FIG. 16 illustrates a microfluidic tile according to the invention having alignment marks, layers and various types of multiplexers;

FIG. 17 illustrates an architecture of a microfluidic tile according to the invention;

FIG. 18 illustrates an architecture of one unite of a microfluidic tile according to the invention; and

FIG. 19 illustrates an architecture and interconnections of a layer within a microfluidic tile according to the invention.

### DETAILED DESCRIPTION OF THE INVENTION

The present invention provides microfluidic tiles that are used within centrifugal rotors and Microsystems and in particular nano-scale or meso-scale microfluidic platforms as well as a number of its applications for providing centripetally-motivated fluid micromanipulation. For the purpose of illustration, the drawings as well as the description will generally refer to centripetal systems. However, the means disclosed in this invention are equally applicable in microfluidic components relying on other forces to effect fluid transport.

For the purposes of this specification, the term “sample” will be understood to encompass any fluid, solution or mixture, either isolated or detected as a constituent of a more complex mixture, or synthesized from precursor species.

For the purposes of this specification, the term “in fluid communication” or “fluidly connected” is intended to define components that are operably interconnected to allow fluid flow between components. In illustrative embodiments, the micro-analytical platform comprises microfluidic tiles within a rotatable platform, such as a disk, or experimental micro-fluidic chips whereby fluid movement on the chip is motivated by centripetal force upon rotation of the chip and fluid movement on the experimental chip is motivated by pumps.

For the purposes of this specification, the term “biological sample”, “sample of interest” or “biological fluid sample” will be understood to mean any biologically-derived analytical sample, including but not limited to blood, plasma, serum, lymph, saliva, tears, cerebrospinal fluid, urine, sweat, plant and vegetable extracts, semen, or any cellular or cellular components of such sample.

For the purposes of this specification, the term “meso-scale”, or “nano-scale” will be understood to mean any volume, able to contain as fluids, with dimensions preferably in the sub-micron to millimetre range.

Representative applications of microfluidic tiles within a centripetal system (e.g., centrifuge) employ rectangular shaped devices, with the rotation axis positioned outside the device's footprint. For the purpose of illustration, the drawings, as well as the description, will generally refer to such devices. Other shapes other than rectangular shaped devices are contemplated within the scope of the invention including but not limited to elliptical and circular devices, irregular surfaces and volumes, and devices for which the rotation axis passes through the body structure, may be beneficial for specific applications.

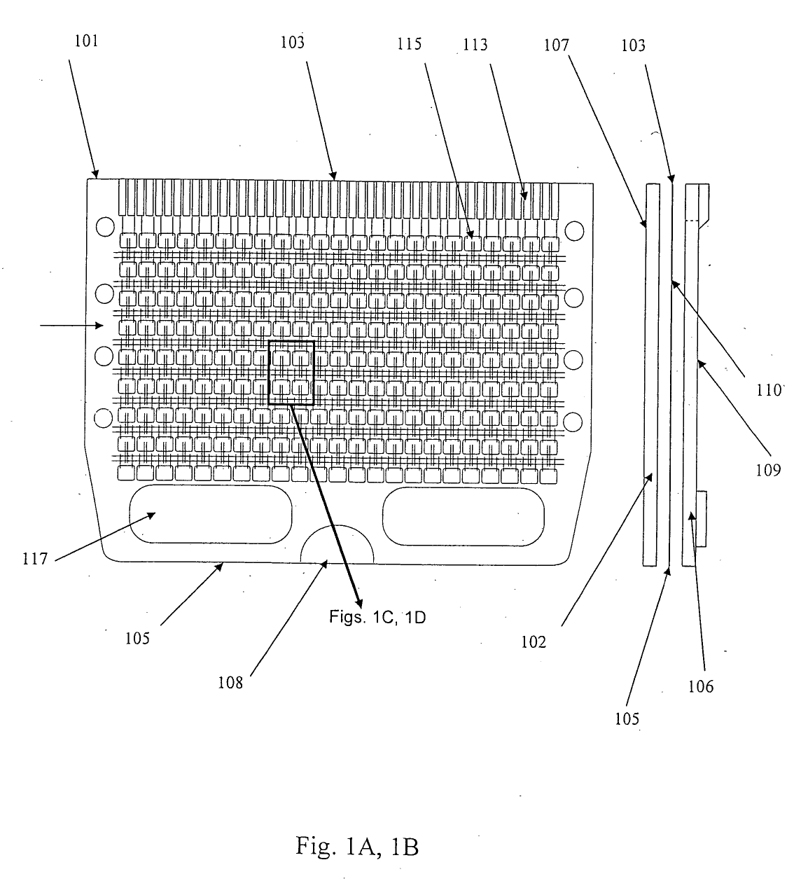

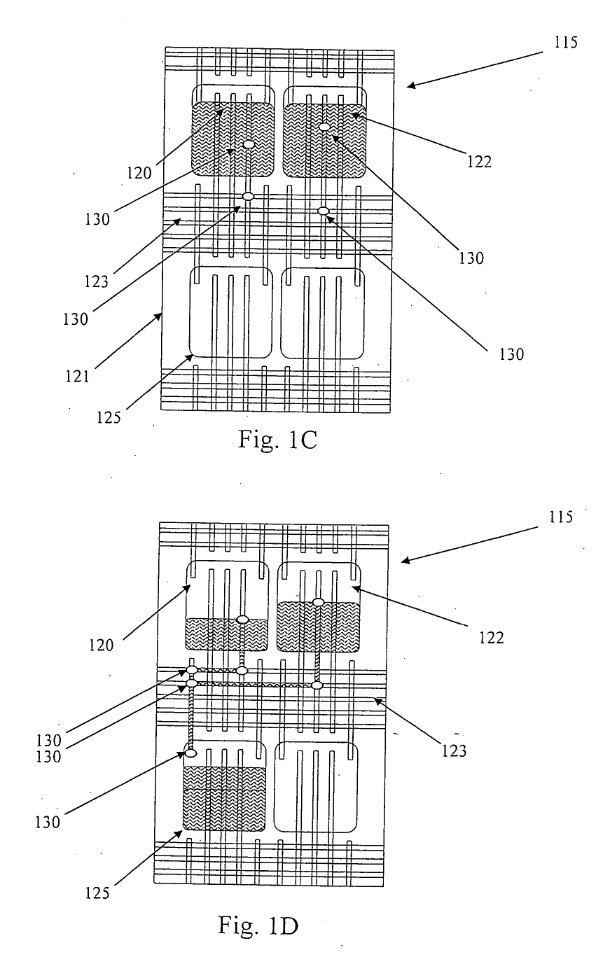

Turning to FIGS. 1A and 1B a first illustrative embodiment a tile 101 according to the invention is shown. The tile 101 is a substantially planar object formed from a first substrate 102 and a second substrate 106. It is contemplated within the scope of the invention that the tile 101 can be also formed from more than two substrates. The substrates 102, 106 can be of any geometric shape. The substrates 102, 106 contain depressions, voids or protrusions that form microfluidic structures when the substrates are bond together. In a first illustrative embodiment the substrates 102, 106 have a film layer 110 sandwiched between them. The film layer 110 allows for separation of voids within the substrates forming microfluidic circuits that can be placed in fluid communication within each other by perforation of the film layer 110. It is contemplated within the scope of the invention that the substrates 102, 106 can be joined within the film layer 110 in between them.

In this first illustrative embodiment the tile 101 is substantially rectangular structure having an input end 103, a bottom end 105, a first planar surface 109 and a second planar surface 108. The bottom end 105 has an affixing tab 107 allowing for handling and insertion of the tile 101 into a holder or frame. In this illustrative embodiment the input end 103, which is also referred to as a small face, has a plurality of input ports 113. The input ports 113 are in fluid communication with at least one fluid handling microfluidic circuit 115. It is contemplated within the scope of the invention that these microfluidic circuits 115 may be composed of a series of valves, chambers, reservoirs, microreactors and microcapillaries. It is also contemplated within the scope of the invention that the series of microreactors and microcapillaries are in fluid communication with a detection chamber.

The tile 101 has an accessory area 117, which can be used for the purpose of manufacturing, handles, structural supports, precision spacers, purging volumes, bonding areas, identification areas or the like.

The functionality of a Specific microfluidic circuit 115 can be configured within the tile 101 to perform a desired assay upon a selected sample. It is contemplated within the scope of the invention that any microfluidic or fluidic assay known in the art can be configured within the tile 101 to achieve a desired functionality. With reference to FIG. 1C a fluidic circuit 121 is shown having a first state having a reagent contained in a first 120 and second 122 reservoir. With further reference to FIG. 1D, the fluidic circuit 121 is shown in a second state after valving within a valving matrix 123 is actuated. It is envisioned that the inventive tiles 101 can having a plurality of fluidic circuits 121 that can perform processes in different regions, by actuating the valving matrix 123 as illustrated by the first and second state of the fluidic circuit 121 as depicted in FIGS. 1C and 1D.

As illustrated in FIG. 1C, a method of joining two fluids in given proportions at a selected time is shown with respect to a first reagent within the first reservoir 120 and a second reagent within the second reservoir 122. According to the invention the first and second reagents are transfer in a desired proportion to a mixing chamber 125. The desired proportion of each reagent is delivered to the mixing chamber 125 by actuating the valving matrix 123 as depicted in FIG. 1D. These reagents can include but not be limited to the dilution of a reagent into a buffer, the occurrence of a chemical reaction with a given ratio of volumes of reagents, modification of the pH of a solution by addition of an acid or a base, an enzymatic assay where a protein comes into contact with an antibody, or the like.

The fluid handling process starts by the opening of a valve 130 within the valving matrix 123, which could of the type described in the patent application WO04050242A2 ('242 application), wherein the film layer is perforated to actuate a valve. The teachings of the '242 application are incorporated herein by reference. It is contemplated within the scope of the invention that the valving mechanism could also be of different types known in the art such as a mechanical valve or the like. According to the invention the reservoirs 120, 122 are positioned onto a different plane with respect to connecting capillaries within the valving matrix 123, and they are separated by means of the film layer 110 that can be perforated at a selected location(s) by irradiation, therefore producing a virtual valve 130 as shown in FIG. 1D.

The opening of valves 130, together with the application of a non-equilibrated force onto fluids, allows for the movement of liquids into the mixing chamber 125. The non-equilibrated force could be generated by means known in the art. In this first illustrative embodiment the non-equilibrated force is achieved by centrifugation so that the liquids are subject to a centripetal acceleration directed towards the bottom of the tile 101. According to the invention the amount of fluids which are transferred to the mixing chamber 125 is determined by the radial position of valves 130, since only the fluid contained above the corresponding valve 130 is allowed to descend into the mixing chamber 125. The process could be replicated in a plurality of subsequent layers, giving the possibility of successive dilution over various orders of magnitude, mixing two or more type of liquids together, incubating fluids for a given amount of time into the reactors, or even performing a real-time protocol over the matrix layers.

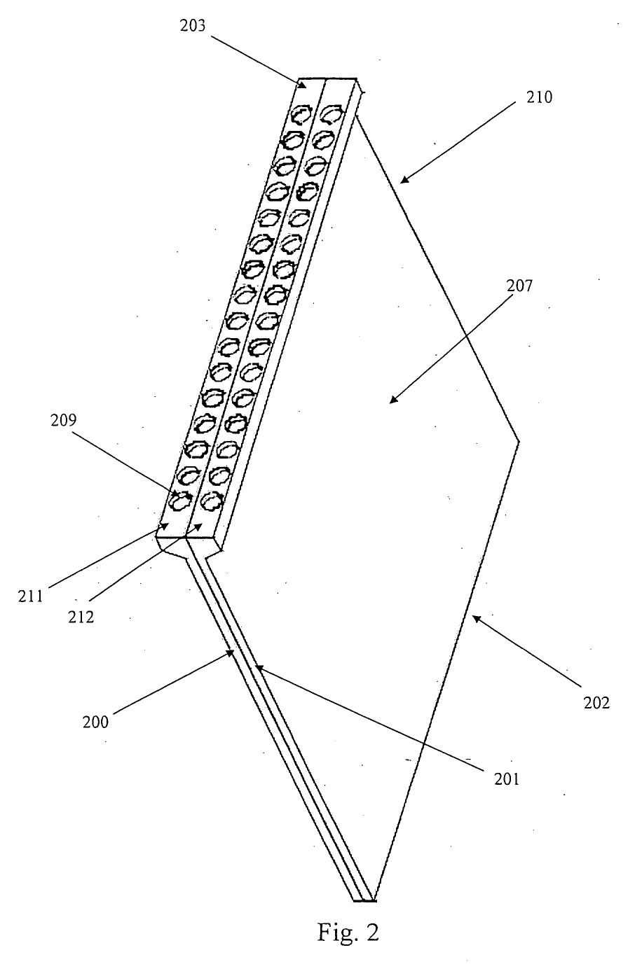

Turning to FIG. 2, a second illustrative embodiment depicting a microfluidic tile according to the invention is shown. The microfluidic tile 210 is comprised of a first substrate 200 and a second substrate 201. The joining of the two substrates 200, 201 forms the microfluidic tile 210. The microfluidic tile 210 has a bottom face 202, an input face 203, a first planar face (not shown) and a second planar face 207. The input face 203, also known as the small face, of the microfluidic tile 201, contains a plurality of input ports 209 in a first input row 211 and a second input row 212. The input face 203 is extruded outside the space confined between the first and second planar faces in order to cause a plurality of microfluidic tiles 210 forming a brick having a desired portal interface.

In this illustrative embodiment, the input face 203 contains input ports 209 that have a pitch and opening dimensions of a standard 384 well micro-plate format. It is contemplated within the scope of the invention that the input ports 209 can be configured to adapt to any standard laboratory interface. The microfluidic tile 210 is suited to manual loading operations, since it is easier to avoid cross-contamination between the inputs ports 209 and to locate the desired input port(s) 209 on the microfluidic tile 210. According to the invention, inputs ports 209 are manufactured symmetrically on the substrates 200 and 201 forming the microfluidic tile 210. These substrates 200, 201 are not simply connected, since their inputs are in fluidic communication with the microfluidic components present at the contact surface of substrates 200 and 201, which is also the surface at which substrates 200, 201 are bonded together.

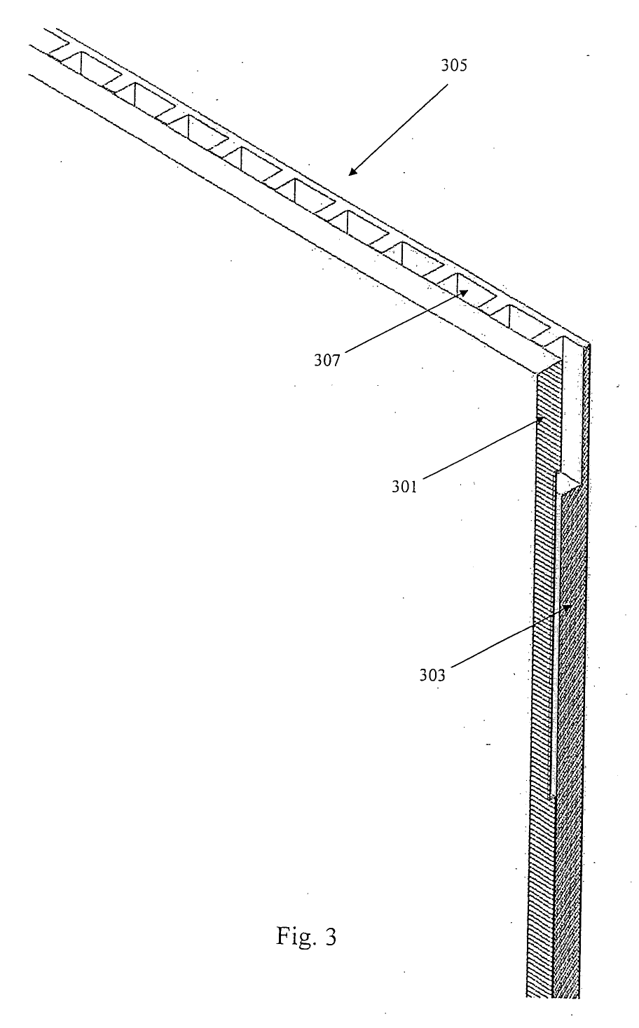

Turning to FIG. 3, an example of a device manufactured by bonding simply connected substrates is shown. A first substrate 301 and a second substrate 303 form a microfluidic tile 305. Inputs 307 are manufactured as depressions on either substrate 301, 303. These depressions are manufactured by microstructuring means. It is contemplated within the scope of the invention that the depressions could also be manufactured by macroscopic means with limited accuracy, for example by milling.

During the manufacturing step, the inputs 307 are not in fluid communication with microfluidic circuits on either on substrate 301 or 303. When the microfluidic tile 305 is assembled there is fluidic communication between the microfluidic circuits and the inputs 307. When the two substrates 301, 303 are bond together fluidic communication with the microfluidic structures is established through the substrates 301, 303. Similarly, all other inputs ports 307 can be put in fluidic communication with the microfluidic circuit of the microfluidic tile 305.

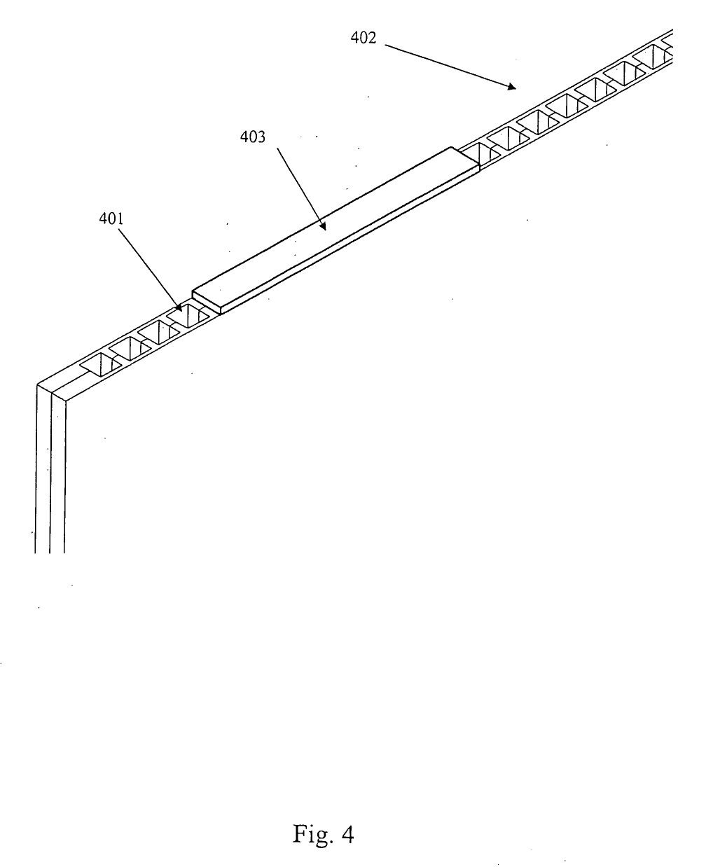

As shown in FIG. 4, a typical requirement of permanent storage applications, like the distribution of a diagnostics assay on a microfluidic device, require reagents to be stored in liquid, solid, encapsulated or lyophilized form inside the microfluidic device. A tile 401 according to the invention having input ports 401 are subsequently sealed by the use of an impermeable cover 403. The use of the impermeable cover 403 covering inputs ports 402 is done routinely in drugs discovery when using standard micro-plates between the operation of loading reagents and the actual assay. The impermeable cover 403 prevents minute quantities of fluid from evaporating, with the consequence of changing their concentration and therefore modifying the assay conditions.

It is contemplated within the scope of the invention that the impermeable cover 403 can be fabricated from polymeric material, natural rubber, or any material having the feature of being inert to liquids used and pierceable for the introduction of liquids, while maintaining gas tightness afterwards to prevent evaporation of store reagents. It is further contemplated within the scope of the invention that the impermeable cover 403 can be obtained by application of a laminated film containing metallic and polymeric layers. The metallic layer allows a low permeability to gas and liquids, and the polymeric layer allows for an easy and effective sealing of the store reagents within the tile 402.

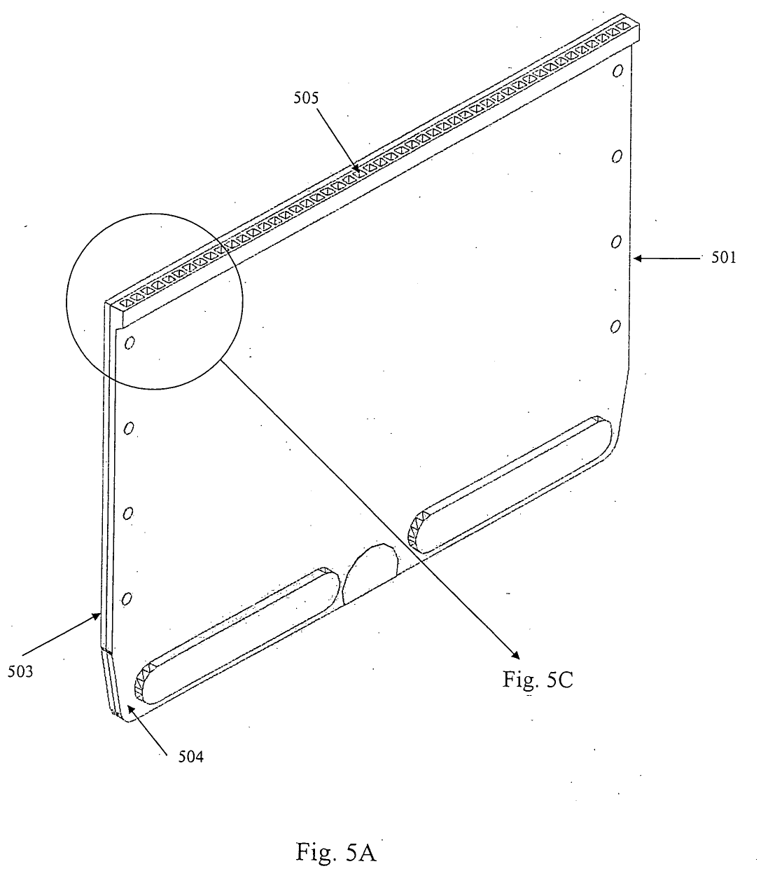

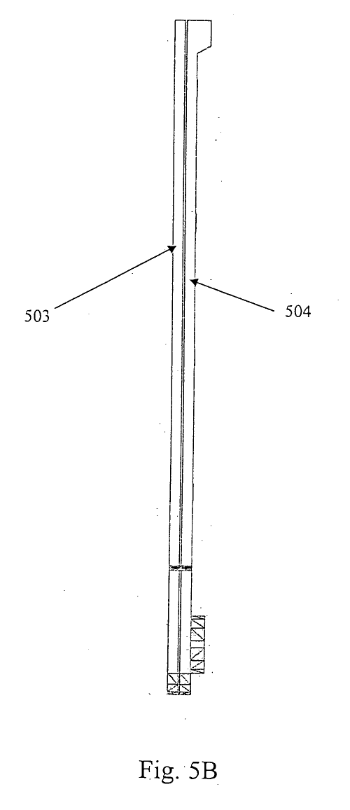

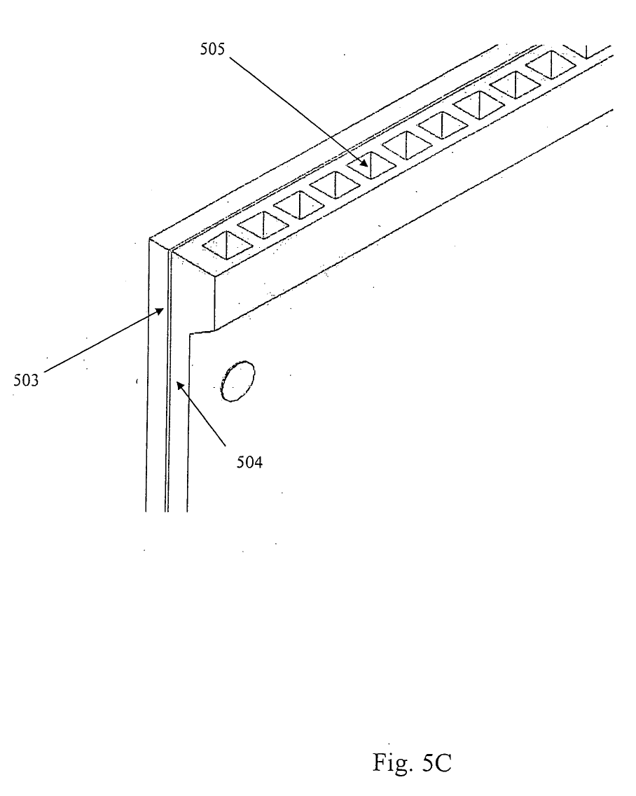

Turning to FIGS. 5A, 5B and 5C, a planar microfluidic tile 501 is produced by micro-structuring a facing surface of one, or both, of a first 503 and second 504 facing substrates. Inputs ports 505 are manufactured in one of the two facing substrates 503, 504 and are completely contained inside one or both of the facing substrates 503, 504. The inputs ports 505 have a length inside the substrates 503, 504 that can be decided arbitrarily accordingly to the fluid volumes to be loaded and the pitch between successive input ports 505 can be chosen accordingly to existing standards and specific integration needs. The nominal pitch values of 2.25 mm, 4.5 mm or 9 mm correspond to the 1536, 384 and 96 wells micro-titre plate standards respectively. In this illustrative embodiment, the pitch chosen corresponds to the 1536 micro-titre plate format, with input ports 505 having a square opening.

The substrate 503, 504 with input ports 505 are simply connected. The input ports 505 can be generated by the same mould insert required for the generation of the microstructures forming the microfluidic circuit, or by a second insert (or mould component) sitting on the same side of the microfluidic circuit generating insert. In both cases, removing the piece from the mould is possible without the requirement of movable parts.

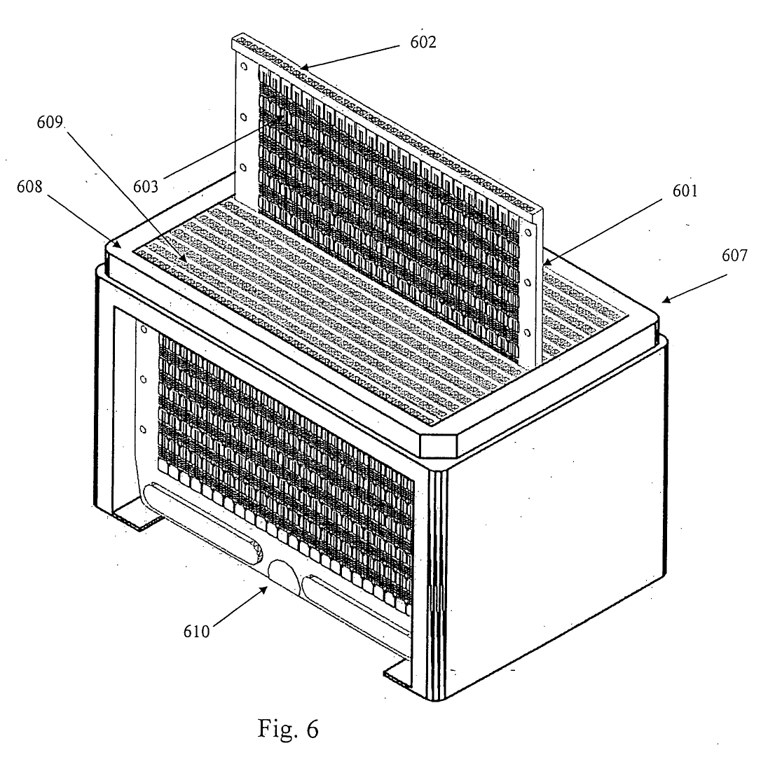

In a further illustrative embodiment as shown in FIG. 6, a microfluidic tile 601 as previously depicted in FIG. 5 contains one row of input ports 602, and a microstructure valving matrix 603 as described in FIG. 1. The microfluidic tile 601 is comprised of a first substrate and a second substrate facing each other and bonded together with a film layer in between.

In this illustrative embodiment, the microfluidic tile 601 has 48 input ports 602, and 16 microfluidic tiles 601 form a brick 607. The brick 607 is kept in place by a frame 608 in this illustrative embodiment. It is contemplated within the scope of the invention that other methods of affixing the microfluidic tiles 601 into bricks 607 can be used. The brick 607 has an upper surface 609 and a lower surface 610. The upper surface 609 is formed from a plurality input ports 602 of the comprising microfluidic tiles 601. The plurality of input ports 602 forms a format of 1536 input ports in a micro-titre plate in a first direction, and the input ports 602 have a pitch of a 384 inputs micro-titre plate in a second direction. The upper surface 609 is a high density region of input ports 602, which allows for an efficient filling of the brick 607 with standard existing multi-head or single-head dispensing devices, which typically have a head pitch compatible with 96 and 384 inputs micro-titre plate formats.

It is contemplated within the scope of the invention that the inventive apparatus and method allows for the assembling of microfluidic tiles 601 in the form of a brick 607 in any standard laboratory format or custom format. Microfluidic tiles 601 within this illustrative embodiment are parallel to the long side of the brick 607, but with a different tile design a brick could host tiles parallel to the short side of the brick 607, with 32 input ports 602 per microfluidic tile 601 (1 series of 32 inputs), the brick 607 containing 16 microfluidic tiles 601.

The number of inputs 602 per microfluidic tile 601, the number of microfluidic tiles 601 in a brick 607, and the orientation of the microfluidic tiles 601 can be changed to achieve various configurations having a standard laboratory format or a custom format. The various configurations are dependent on the microfluidic tile 601 design and on the application and strategy to collect the microfluidic tiles 601 into a micro-plate-like format. The segmentation of microfluidic tiles 601 and the number of input ports 602 on the microfluidic tile 601 can be made without requiring changes to the fluid handling device and to the loading process.

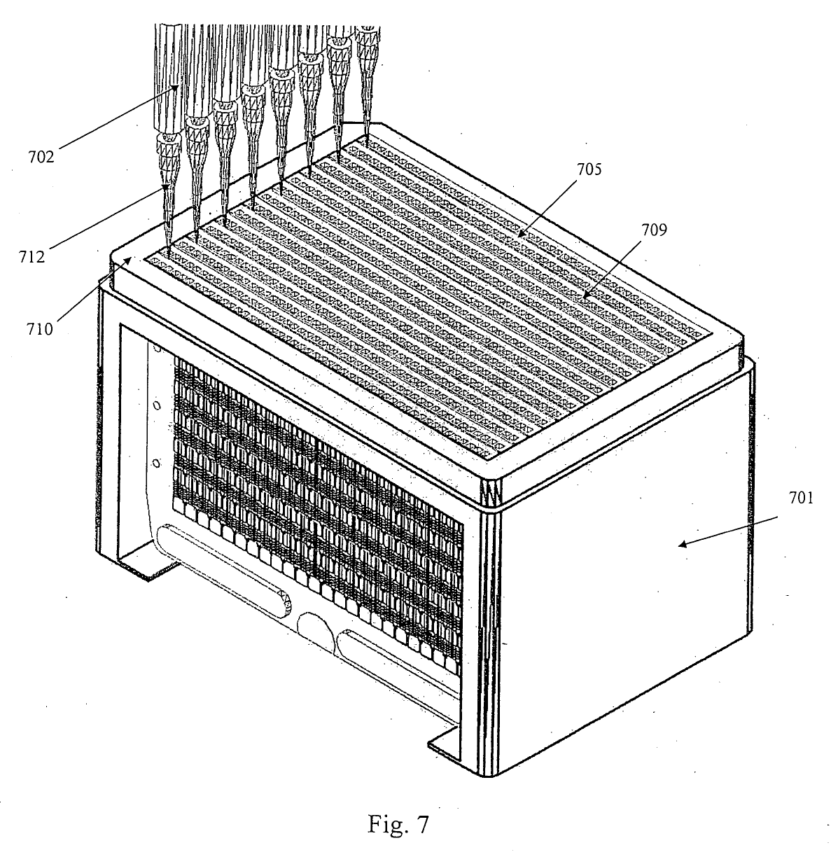

Turning to FIG. 7, the loading operation of a brick 701 with a 96 inputs micro-plate parallel dispenser 702 is depicted. The brick 701 in this illustrative embodiment is formed from a plurality of tiles 705 having a plurality of input ports 709. The parallel dispenser 702 has 8 heads 712 and performs the loading by columns. In this illustrative embodiment, the heads 712 move parallel to the long side of the brick 701, and allows the dispensing of a reagent or other selected fluid into the input ports 709 of the tile 705. Since many assays consists in the repetition of a protocol to test different targets or different chemical entities in parallel, a fraction of the reagents or selected fluids of the assay are in common, and a fraction of the reagents are varied. Once a reagent is available in one dispenser head 712, it can therefore be distributed over different tiles in an efficient manner since the tiles require small volumes and the pipette tip is used once for all tiles contained in the brick.

The parallel dispensing device 702 has a typical pitch since most of the dispensing heads are larger than the pitch of a 1536 micro-plate to maintain compatibility with the lower density formats containing 384 and 96 wells per micro-plate. In this illustrative embodiment, the spacing for the inputs is determined by a protruding structure of the tiles 705 and by the brick frame 710. It is contemplated within the scope of the invention that the tiles 705 can be kept vertical by a comb-like support.

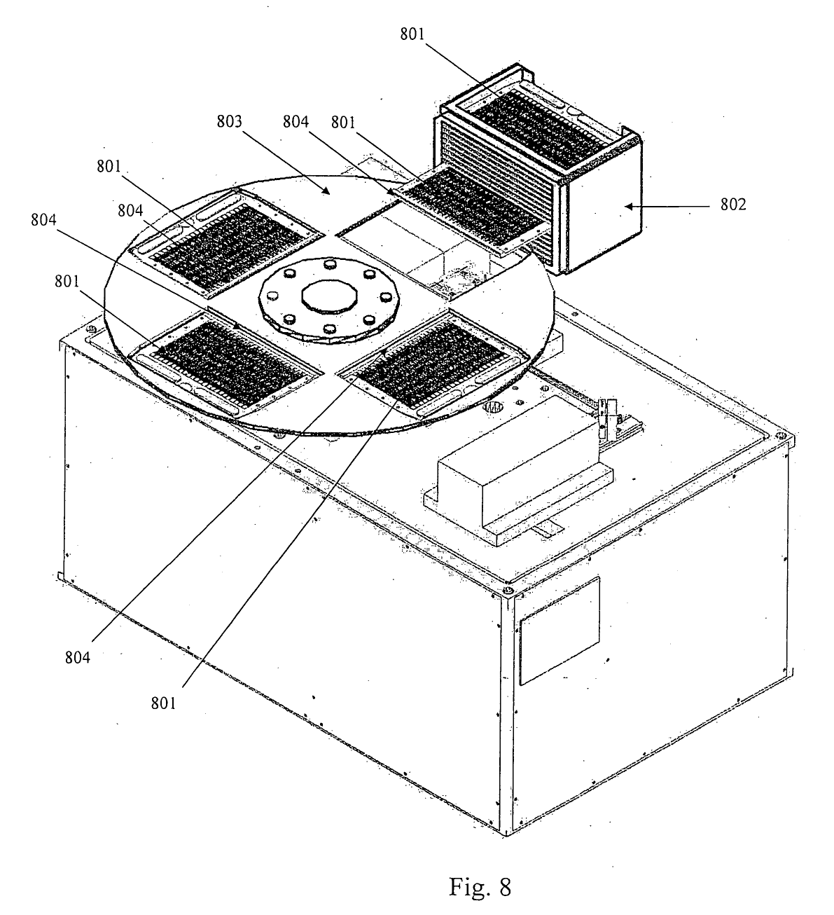

As shown in FIG. 8, tiles 801 according to the invention after being disassembled from a brick 802 in a manual or automated way are positioned on a spindle support 803 at constant radius. The tiles 801 can be processed individually or in groups, according to the throughput needs. It is contemplated within the scope of the invention that it is not required to position the tiles 801 at a constant distance from the rotation axis, and that the tiles 801 can be loaded in multiple rows in order to save space occupation on the spindle support 803. According to the invention, it is preferable to have inputs 804 on the edge of the tiles 801 facing the rotation axis. This positioning is desirable since fluids subject to the centripetal acceleration will tend to move radially towards the outer part of the spindle and the input 804 can be optimally designed for fluid collection.

Inputs 804 on the main faces are configured to avoid spill-over. When inputs 804 of the tile 801 are on the small face as previously discussed, an additional advantage consists in the removal of bubbles. In fact, atmospheric pressure air has a density lower than the density of any liquid. Gas bubbles are also subject to the Archimedes principle. In the case of air in a liquid at rest, a bubble can remain inside the liquid if the weight of the bubble, summed with the surface tension forces, overcomes the Archimedes force. In a centripetal device, gravity is rapidly overcome by spinning.

A bubble in a centripetal device, therefore, can be subject to a strong force directed towards the rotation axis and perpendicular to it, whose intensity is equal to the apparent weight of the liquid displaced. Inputs 804 should be placed on the faces of the tile 801 that are directed towards the rotation axis, since the centripetal force will push the bubble towards the liquid/air interface with the result of bubble disappearance. The same consideration applies to the case where the fluid loaded by the external dispensing system sits on top of an air volume, a phenomenon that typically occurs when the introduction of liquid does not happen at the very bottom of the container itself. This phenomenon is typical of small-sized ports since the fluid rapidly occludes, by surface tension occurring at the contact region with the side walls, the passage of underlying gas towards the opening. The centripetal acceleration in the side input configuration previously described will drive the fluid to the “bottom” of the inlet.

Processing of a brick 802 can be accomplished in different ways, in relation with the specific microfluidic technology contained in the tiles 801. An example of brick 802 processing can therefore be made with reference to the microfluidic technology disclosed in the international application WO04050242A2, in the specific embodiment where the valving technology is used in a centripetal platform. In this embodiment, the tiles 801 can be processed on a centripetal platform, that spins in order to position the valve actuator in the correct position, can move the fluids inside the tiles by centrifugation, and allows the readout sensor to detect the outcome of the assay in a localized position.

As shown in FIG. 8, the platform is similar in many aspects to a centrifuge rotor hosting horizontal tiles. The tiles 801 can be transferred from the brick 802 to the rotor in many ways, one method shown in the figure as an example. The steps of the process can be identified in brick loading, tile extraction, tile positioning, tile processing, tile unloading. The brick 802 can be loaded on the instrument with tiles 801 in the horizontal position, profiting of the fact that the fluids do not escape from the inlets due to surface tensions (or by means of seals applied to the inlet). Vertical translation of the brick 802 in the picture allows choosing the tile 801 to be processed: without the need of direct tiles identification, this method allows a unique association of the tile 801 being processed with the micro plate column (or row) that was loaded with the reagents.

Tile extraction from the brick 802 can be achieved by application of pressure through an external actuator, for example pushing the bottom of the tile in the direction towards the rotor axis. In another illustrative embodiment, the tile 801 could be grasped by a clamp, or specific structures created on the tile 801 (like a pin, a hole, a flap, a flange, a bayonet, a magnet, an adhesive layer) could be used as means to establish a link with the actuator. Tile positioning can be achieved by moving the extracted tile 801 vertically inside the rotor slot specifically designed to host the tile 801.

In a further illustrative embodiment, the rotor could present slots which are accessible from the outer part of the rotor, and the tile 801 is locked inside the slot by an active mechanism, like a key or an electromechanical actuator, preventing the tile 801 to escape from the rotor as consequence of spinning.

Tile processing occurs by opening in an active way the valves in the tile 801, by means of an optical pickup positioned below the rotor, and the readout of the assay is performed by means of the same optical path. It should be noted that in this configuration an identifying barcode of the tile 801 could be also positioned on the main face of the tile 801, and read during the spindle rotation. In fact, even if the barcode is not optically accessible when the tiles 801 are grouped in the brick 802, the reading of the barcode while the tile 801 is positioned onto the rotor allows performing the unique association of the tile position in the brick (in other words, the column or the row identifier of the micro plates) with the tile barcode, making unnecessary additional tile identification procedures.

After processing, tile unloading can be achieved by repositioning the tile 801 inside the brick frame (in the same position or in a different position) through the same movement path. As another possibility for tile unloading, the tile 801 could be disposed by completely lifting up (or down) the brick vertical translator, to a disposing unit that could be similar to a brick or to a simple pile of tiles for disposal.

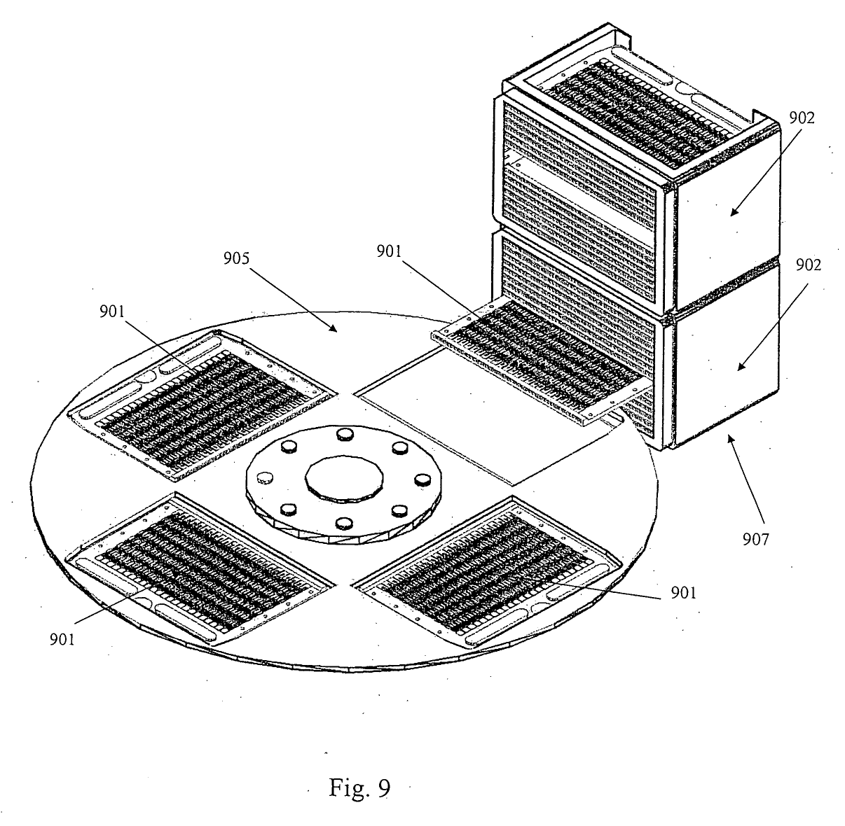

As shown in FIG. 9, it is envisioned that various schemes for brick processing are not limited to transferring a tile 901 from a brick 902 to a processing instrument 905, but refers also to the process of moving tiles 901 from a plurality of bricks 902 to an instrument without substantial modifications. In one aspect of the invention, bricks 902 are stacked in a vertical pile within a brick loader 907, and selected for loading by simple vertical translation of the brick loader 907.

The brick 901 according to the invention can therefore be designed to allow for vertical stacking of multiple bricks 902, as it is conventionally done in well plates, but also to stack bricks 902 which contain horizontal tiles 901, with the purpose of side stacking. The stacking of the tiles 901 according to the invention could be facilitated by mechanical positioning means, for example pins, slots, “lego connections,” extruding complementary structures and similar, in order to allow both vertical and side stacking of bricks 902. It is contemplated within the scope of the invention that the possibility of assembling a plurality of bricks 902 and treating them as a single brick 902 is essentially possible in all steps, including brick loading with fluids, being this feature essentially connected to the modular concept of assembly of the tiles 901.

The number of loading steps is determined by the overall number of different basic reagents present in an assay. In typical chemical screening procedures, a number N of chemical compounds is screened versus a number M of targets (for example, proteins) on the basis of the result of an assay, that typically comprises a small handful of reagents (in the following consideration and for this purpose, neglected), operation also known under the term of compounds profiling.

Compound profiling procedures in the drug industry are common, and for example one of them consists in the determination of the enzymatic activity of a family of kinase proteins in presence of various kinase inhibitors. Kinase profiling has the important goal to assess the potency of a potential drug while measuring the side effects of the same molecule towards other proteins of the same family but regulating different biological processes. In the operation of compound profiling, the number of useful data points is essentially proportional to N times M, while the number of loading operations consists in N plus M steps.

If all the steps subsequent to the loading process are automated, there is a significant scaling advantage in collecting together microfluidic devices to produce in one go as many data points as possible, as done in the present invention, since the loading steps will only moderately increase: for example, screening 10 compounds vs. 10 targets produces 100 data-points with essentially 20 loading steps, while screening 100 compounds vs. 100 targets produces 100 times more data-points, with only a ten-fold increase of the loading steps (i.e. the amount of work done by the user). The same argument for integration and collective interface is valid for most drug discovery and diagnostics applications, where a panel of a plurality of assays is performed on a plurality of biological samples, and we can predict that the future evolution of pharmaco-genomics will increase the demand and the utility of panels meant to screen the patient compatibility with potential therapeutic agents.

Tiles according to the invention are advantageously provided having a variety of composition and surface coatings appropriate for a particular application. Tile composition will be a function of structural requirements, manufacturing processes, reagent compatibility and chemical resistance properties. In particular, tiles may be made from inorganic crystalline or amorphous materials, e.g. silicon, silica, quartz, inert metals, or from organic materials such as plastics, for example, poly(methylmethacrylate) (PMMA), acetonitrile-butadiene-styrene (ABS), polycarbonate, polyethylene, polystyrene, polyolefins, polypropylene and metallocene. These may be used with unmodified or modified surfaces.

Surface properties of these materials may be modified for specific applications. Surface modification can be achieved by such methods as known in the art including by not limited to silanization, ion implantation and chemical treatment with inert-gas plasmas. It is contemplated within the scope of the invention that tiles can be made of composites or combinations of these materials, for example, tiles manufactured of a polymeric material having embedded therein an optically transparent surface comprising for example a detection chamber of the tile.

It is further contemplated within the scope of the invention that tiles can be fabricated from plastics such as Teflon, polyethylene, polypropylene, methylmethacrylates and polycarbonates, among others, due to their ease of moulding, stamping and milling. It is also contemplated within the scope of the invention that tiles can be made of silica, glass, quartz or inert metal. The tiles having a fluidic circuit within in one illustrative embodiment can be built by joining using known bonding techniques opposing substrates having complementary microfluidic circuits etched therein.

Tiles of the invention can be fabricated with injection moulding of optically-clear or opaque adjoining substrates or partially clear or opaque substrates. The tiles can be square, rectangular or any geometric form with a thickness approximately comprised between 1 mm and 10 mm. Optical surfaces within the substrates can be used to provide means for detection analysis or other fluidic operations such as laser valving. Layers comprising materials other than polycarbonate can also be incorporated into the tiles.

The composition of the substrates forming the tile depends primarily on the specific application and the requirements of chemical compatibility with the reagents to be used with the tile. Electrical layers and corresponding components can be incorporated in tiles requiring electric circuits, such as electrophoresis applications and electrically-controlled valves. Control devices, such as integrated circuits, laser diodes, photodiodes and resistive networks that can form selective heating areas or flexible logic structures can be incorporated into appropriately wired areas of the tile. Reagents that can be stored dry can be introduced into appropriate open chambers by spraying into reservoirs using means known in the art during fabrication of the tiles. Liquid reagents may also be injected into the appropriate reservoirs, followed by application of a cover layer comprising a thin plastic film that may be utilized for a means of valving within the fluidic circuits within the tile.

The inventive microfluidic tiles may be provided with a multiplicity of components, either fabricated directly onto the substrates forming the tile, or placed on the tile as prefabricated modules. In addition to the integral fluidic components, certain devices and elements can be located external to the tile, optimally positioned on a component of the tile, or placed in contact with the tile either while rotating within a rotation device or when at rest with a brick formation or with a singular tile.

Fluidic components optimally comprising the tiles according to the invention include but are not limited to detection chambers, reservoirs, valving mechanisms, detectors, sensors, temperature control elements, filters, mixing elements, and control systems.

### EXAMPLES

The following examples are provided to illustrate the methods and products of the present invention with particular choices for the several components described above. As described above, many variations on these particular examples are possible. These examples are merely illustrative and not limiting of the present invention.

### Example I

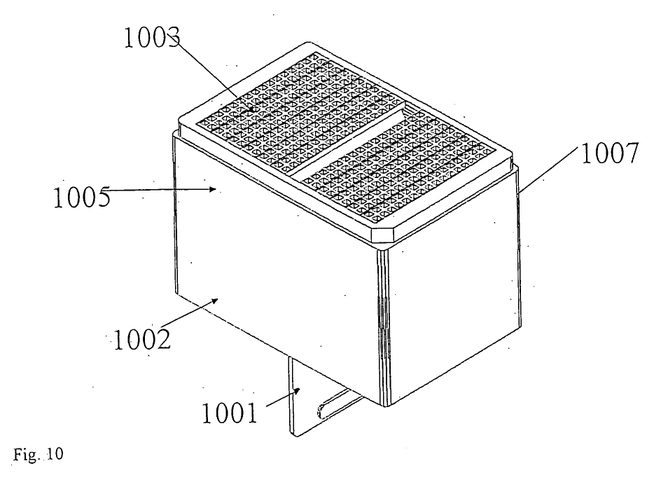

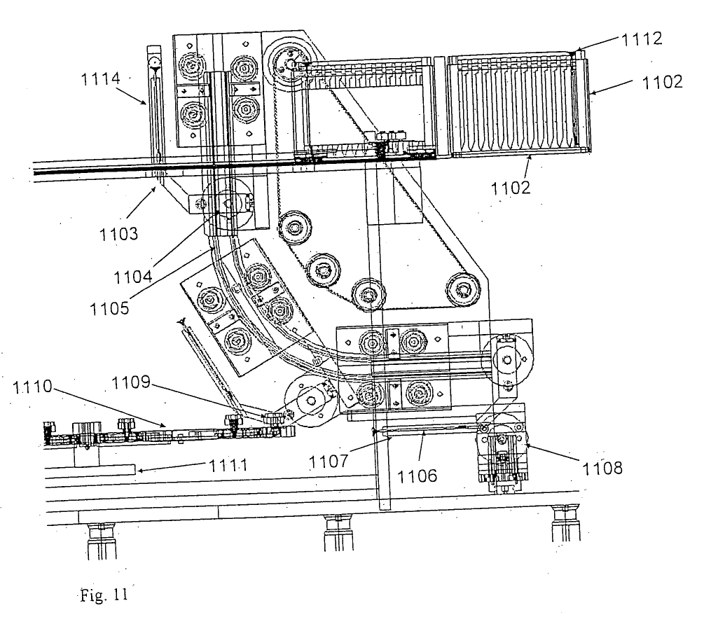

A brick 1000 according to the invention is shown in FIG. 10. The brick 1000 is comprised of a plurality of microfluidic tiles 1001 within a brick frame 1005. In a first illustrative embodiment, the tiles 1001 are extracted from the bottom of the frame 1002, in order to be processed by related devices. The microfluidic tiles 1001 are accessed by microfluidic inlets 1003 on the top face of the brick 1000.

This illustrative embodiment allows a human interface that is designed independently from the machine interface. Reagents may be loaded in the inlets 1003 at the top face of the brick 1000, either by manual or automated means. The inlets 1003 are arranged in a conventional micro-plate format. As microfluidic technologies consume a very limited amount of reagents, the reagent volumes are substantially small. It is known in the art that small volumes of liquids are subject to rapid evaporation, that may either deplete the liquid or change the concentration of the reagents due to evaporation. A solution to this evaporation problem consists of the application of an adhesive polymer film (not shown) on top of the top face after reagent loading. The adhesive polymer film can be either temporary or permanent, by the use of thermal adhesives, pressure sensitive adhesives or similar means to guarantee the gas tightness, which prevents liquid evaporation by an increased vapour pressure.

It is contemplated within the scope of the invention that the same sealing means can be used with the brick 1000. The brick 1000 is characterized by bottom extraction as shown in FIG. 10. Bottom extraction has the advantage that a film layer (not shown), positioned on the top face, can be kept in place until a tile 1001 is extracted from the frame 1002 minimizing the time that liquids are exposed to air, thereby improving the assay quality and minimizing the risk of external contamination.

Tiles 1001 and frames 1002 according to the invention are designed in a manner so that, during normal laboratory operations, the tiles 1001 do not exit from the bottom of the frame 1002. In one illustrative embodiment adhesive fasteners prevent the tiles 1001 from slipping out of the frame 1002. In a further illustrative embodiment mechanical means are used that are externally actuated in order to release one or a plurality of tiles 1001 from the frame 1002. It is contemplated within the scope of the invention that the removal of tiles could be achieved by any mechanical means such as a tab, a lever, or the like.

In a further illustrative embodiment, elastic elements either in the tile 1001 or in the frame 1002 or in both, exerts pressure in a location of the tile 1001 so that undesired tile extraction is avoided. The extraction of tiles 1001 can be achieved by application in the direction towards the bottom opening 1007 by means of pushing or pulling pins, pushing or pulling rods, various types of clamps, grips, friction wheels, rotating gears, sliding bars or the like. In particular, elastic elements may be integrated into the frame 1002, minimizing the complexity and the cost of the tiles 1001.

### Example II

Turning to FIG. 11, an automated extraction solution for tile removal is shown. In a first illustrative embodiment, a selected microfluidic tile 1112 in a brick 1102 is chosen for extraction by a linear movement of a tray 1101. In this illustrative example, only one brick 1102 is accessed by the extraction device. It should be understood by those skilled in the art that this de-assembly procedure can be applied, sequentially or in a desired order, to a plurality of bricks 1102, either in an instrument or in a production line. This type of automation is an efficient solution allowing for a high throughput or unattended production line, ranging from compound loading, reagent distribution, protocol execution and experiment readout. The production line could be assembled by a rail or belt driven mechanism where bricks 1102, with or without reagents, are fed into the slots of a conveyor, and a continuous flow of experiments can be performed either serially or in parallel by means of “bifurcations” of the conveyor, tile extraction, re-distribution and brick manipulation.

As shown in FIG. 11, microfluidic tiles 1112 are extracted by means of a gripper 1103, that grasps the tile 1112 from the bottom. In a first illustrative example, a purge volume 1008 on the tile 1112 is configured so that the movement of the gripper 1103, actuated by solenoids 1104 or stepper motors, pneumatic actuators or the like, exerts pressure on the tile 1112 allowing for a firm holding of the tile 1112 in the gripper 1103. A curvilinear rail 1105 is configured to transport the gripper 1103 along a complex trajectory, by taking a vertical tile 1114 contained in a brick (not shown ) to an operational position 1106, where the tile is horizontal. The fingers 1107, actuated by pneumatic or electrical means like solenoids 1108 or electrical motors, open fixation holders 1109 on a spindle 1110, at which moment the linear stage 1111 allow the movement of the spindle 1110 onto the tile 1112 in a set position 1106.

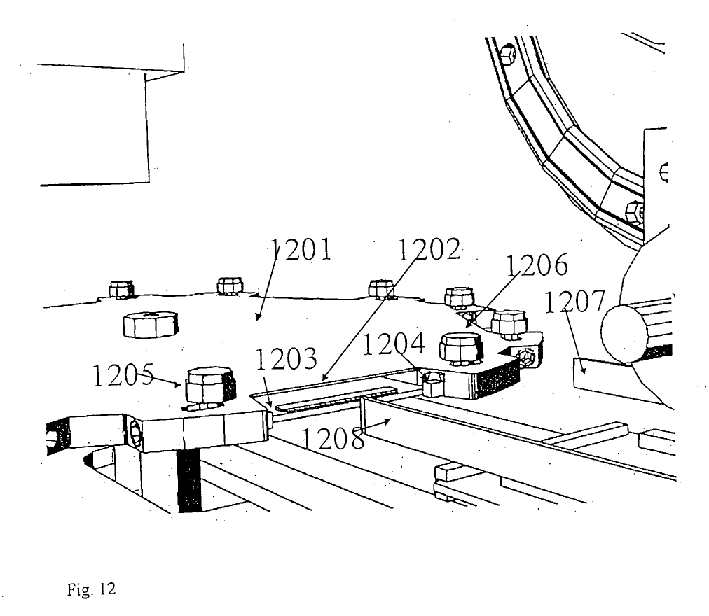

As is shown in FIG. 12, the spindle 1201 has insertion slots 1202 meant to keep tiles in a rotor. The tiles are locked radially by holding means 1203, 1204 actuated by knobs 1205, 1206 by means of fingers 1207, 1208. With further reference to FIG. 11, fingers 1107 are de-energized, and the pressure from the gripper 1103 is released from the tile 1106. Turning to FIG. 12, the tile is kept inside the slot 1202 of the spindle 1201, and the subsequent movement of the spindle 1201 drags the tile away from the loading mechanism, which is therefore ready for the next operation. Similarly to loading operations, unloading of tiles (from spindle to a frame) can be performed in a similar manner by the inverse path. It should be noted that a tile could also be sent to another brick, or to an area dedicated to specific purposes like tile disposal or tile incubation.

### Example III

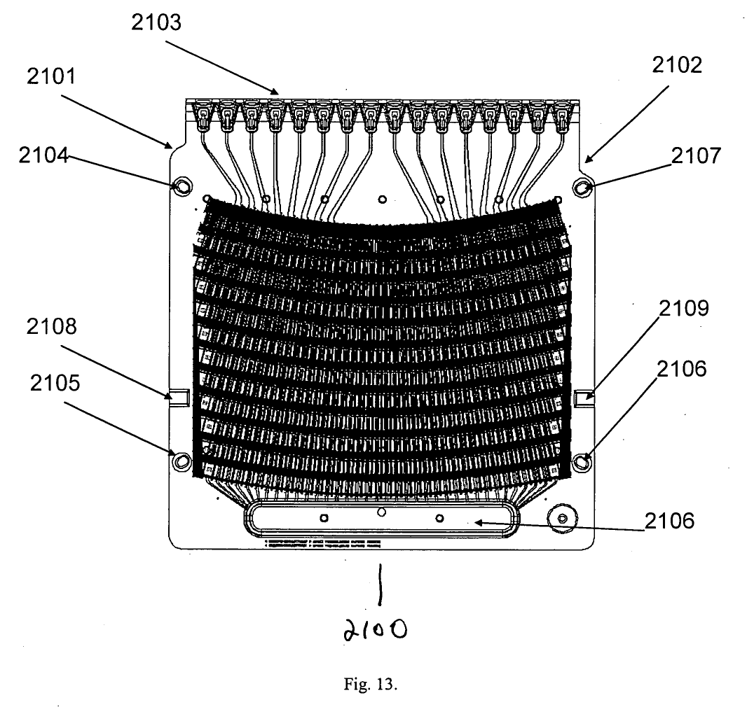

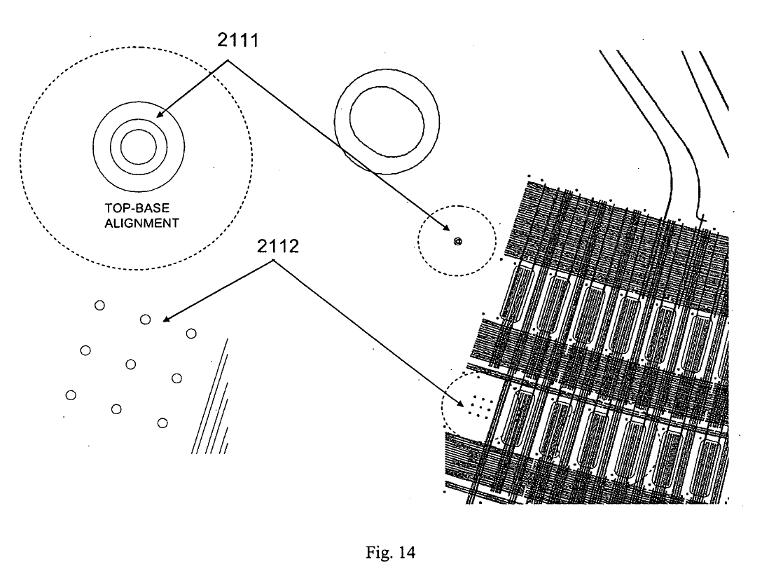

An further illustrative example of microfluidic tile 2100 according to the invention suitable for production by injection molding is shown in FIG. 13. A configuration to prevent improper insertion of the tile 2100 into a brick is shown in a first and second locations 2101 and 2102. The asymmetric design of the tile 2100 according to the invention implies a different height of its right and left edges, corresponding to a complementary design of a brick frame according to the invention that would produce interference in case of rotation of the tile 2100 in the frame. In this illustrative example, 32 inlets in position 2103 are organized as two rows of 16 wells spaced by about 4.5 mm in a 384-microplate format configuration, and constitute the inlets of the tile where the user provides the reagents for processing. Location pins 2104, 2105, 2106, 2107 determine the mechanical alignment of the two constituting sides of the tile 2100, and a safe and solid connection between them. Snap-in depressions 2108 and 2109, allow for tile 2100 insertion from the bottom of the brick without the undesired consequence of the tile 2100 falling down after insertion. A plurality of tiles 2100 are kept in the frame by elastic elements connected to keys that snap into depressions 2108 and 2109. The purge 2110 in the tile 2100 is conveniently located below the microfluidic area of the tile 2100 in order to collect the waste from the reactions in the microchambers and possible overflow from the inlets.

### Example IV

A further example of the microfluidic tile according to the invention is shown in FIG. 14. As depicted in FIG. 14, a solution for tile alignment marks 2112, 2111 is shown. Alignment marks 2112, 2111 are meant for the precise location of the microfluidic structures, within the tile, with the purpose of readout, imaging and valving operations, but also for correct manufacturing of the microfluidic tile. These alignment marks 2112, 2111 allow assembly at minimal cost since typically the two substrates forming a microfluidic tile according to the invention have to be precisely aligned and bonded. The alignment mark 2111 can be simply made by microstructuring, during the part production, the two sides with defined and complementary shape, in this case a circle surrounded by a ring. This alignment feature allows, during manufacturing, the determination of the correct positioning of the complementary parts. The other alignment mark 2112 for example is more suitable to camera inspection and precise determination of the relative rotation, and can be produced by various techniques including ink spotting and post-processing of the consumable.

### Example V

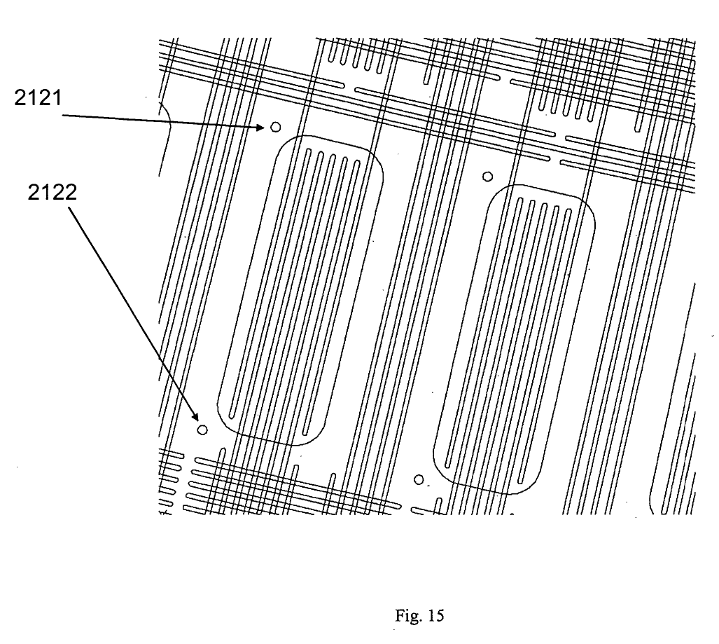

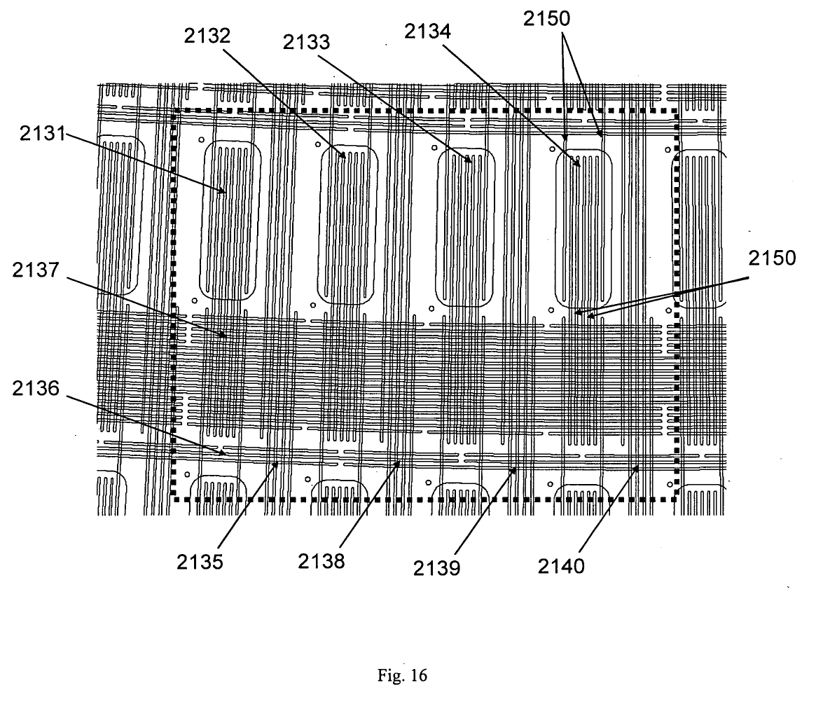

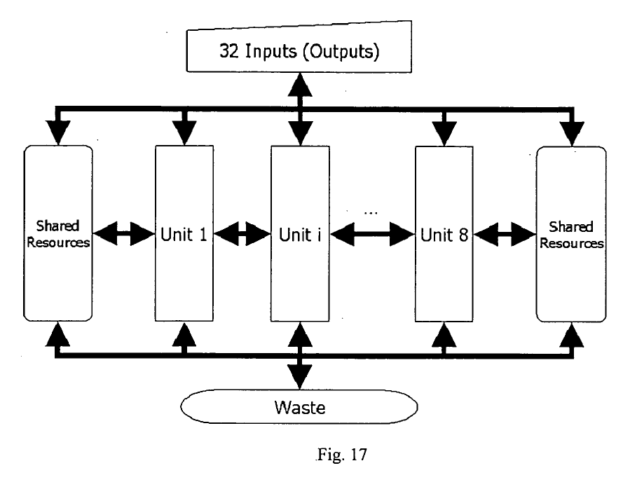

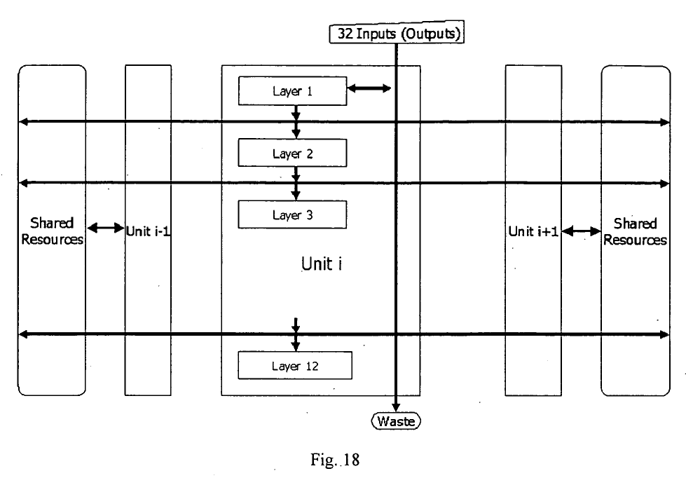

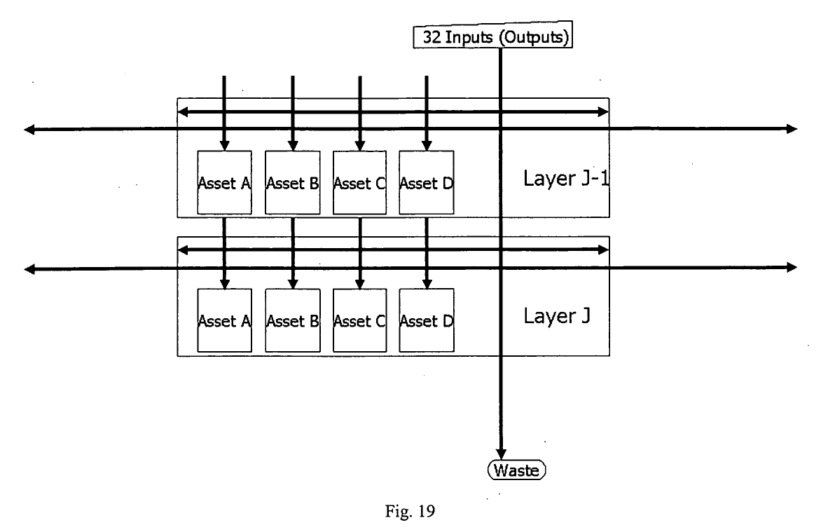

Turning to FIG. 15, an alternative type of alignment marks within a microfluidic tile according to the invention is shown 2121 and 2122. These alignment marks 2121, 2122 are engraved on only one of the sides of the card, and are used to correct for local distortions induced by the manufacturing process of the structured polymer parts. These structures 2121, 2122 are located at a known distance and relative displacement, the measurement of the actual displacement conveys information on the amount of distortions, rotation or dislocation of the two sides of the card. The role of these alternative alignment marks is visible in FIG. 16, where different microfluidic components according to the invention are shown. In particular, dosimeters 2131, 2132, 2133, 2134 and the neighbouring microfluidic matrices called columns 2135, 2138, 2139, 2140 sub-multiplexers 2136 and multiplexers 2137 are organized in a logical functional unit called layer. The layer is depicted by those structures surrounded by a dashed line. To further understand the potential role of the various microfluidic components, the overall card architecture depicted in FIG. 17. The card can be subdivided in various functional areas, similarly to the design of electronic chips, composed by a number of (identical or similar) units, input and output connections, and shared areas that can provide services to the various units. The Unit, whose architecture is depicted in FIG. 18, has the functionality of communicating fluids with the outside world. The unit also has the functionality to efficiently mix, dispense, and dilute fluids among layers internally located. The layers have both local multiplexers to efficiently move fluids without consumption of capillaries and preventing contamination, but also global lines, that allow for example to reach the shared resources or other units. The internal structure of one layer is shown in FIG. 19, which in this particular illustrative example is composed by four assets, which correspond to the dosimeters 2131-2134 depicted in FIG. 16 together with the capillaries and channels that make them operational, for example input lines 2150 and output lines 2151, as shown in FIG. 16.

The depicted logical organization of the card makes the functionality of the tile (and of the brick containing a set of cards) useful and easily programmable by software means, similarly to what happen, for example, in the field of electronics related to Field Programmable Gate Arrays (FPGA).

Although examples of brick processing is specific to the instrument and to the valving technology disclosed, it should be understood by those skilled in the art that the same principle could apply to systems employing passive valving systems, or to valving systems based on mechanical and electrical actuators, both in centripetal and non centripetal environments.

Although the illustrative microfluidic tiles according to the invention are construction of a first and second substrate with a film layer in between, it should be understood by those skilled in the art that the microfluidic tiles of the invention can be formed from a plurality of substrates. Likewise it should be understood by those skilled in the art that the substrates can be assembled with or without film layers in between.

Although the illustrative microfluidic tiles according to the invention are utilized in nano or meso scale embodiments, it should be understood by those skilled in the art that the principle disclosed herein can be applied to fluid handling technologies regardless of scale.

The principles, preferred embodiments and modes of operation of the presently disclosed have been described in the foregoing specification. The presently disclosed however, is not to be construed as limited to the particular embodiments shown, as these embodiments are regarded as illustrious rather than restrictive. Moreover, variations and changes may be made by those skilled in the art without departing from the spirit and scope of the instant disclosure and disclosed herein and recited in the appended claims.

What is claimed is:

1. An apparatus for performing an assay comprising:
a tile having a top and bottom planar surface said tile further having an input end and an opposing end, said input end having at least one input port;
at least one fluidic handling component between said top and bottom planar surface of said tile, said at least one fluidic handling component being in fluid communication with said at least one input port.

2. The apparatus according to claim 1 further comprising a means for affixing said tile to additional tiles.

3. The apparatus according to claim 1 wherein said tile has means for affixing to a centripetal rotor apparatus.

4. The apparatus according to claim 1 wherein said at least one fluidic handling component is selected from the group consisting of channels, detection chambers, reservoirs, valving mechanisms, detectors, sensors, temperature control elements, filters, mixing elements, and control systems.

5. The apparatus according to claim 1 wherein said tile is affixed to a plurality of tiles said plurality forming a tile brick.

6. The apparatus according to claim 1 further comprising a means for identification of said tile.

7. The apparatus according to claim 5 further comprising a means for identification of said brick.

8. The apparatus according to claim 6 wherein said identification means are selected from the group consisting of optical identification, mechanical identification, physical identification, electrical identification, magnetic identification and radio identification.

9. The apparatus according to claim 5 wherein said tile brick comprises a plurality of input ports said input ports forming a standard laboratory input format.

10. The apparatus according to claim 5 wherein said tile bricks are stackable.

11. The apparatus according to claim 10 wherein said stackable tile bricks are stackable with input ports on the top of the brick.

12. The apparatus according to claim 10 wherein said stackable tile bricks are stackable with input ports on a side of said tile bricks.

13. The apparatus according to claim 10 wherein said stackable tile bricks are stackable with input ports on the top of said tile brick and with input ports on a side of said tile brick.

14. The apparatus according to claim 1 wherein said tile contains a multiplicity of fluidic components.

15. The apparatus according to claim 1 wherein said tile is formed from a material selected from the group consisting of Teflon, polyethylene, polypropylene, methylmethacrylates, polycarbonates, silicon, silica, acetonitrile-butadiene-styrene (ABS), polycarbonate, polyethylene, polystyrene, polyolefins, metallocene or mixtures thereof.

16. The apparatus according to claim 1 wherein said tile further comprises additional components selected from the group consisting of electrically-controlled valves, integrated circuits, laser diodes, photodiodes and resistive heating elements, hot and cold points and optical components.

17. The apparatus according to claim 1 wherein said input port further comprises a means for sealing.

18. The apparatus according to claim 17, wherein the means for sealing is a film.

19. The apparatus according to claim 18, wherein said film is a self-sealing.

20. The apparatus according to claim 17 wherein the means for sealing is a micro plate cover.

21. The apparatus according to claim 17, wherein the means for sealing seal a subset of the available input ports.

22. The apparatus according to claim 17, wherein said input ports are pre-loaded with gaseous, liquid or solid reagents.

23. The apparatus according to claim 17, wherein said input ports are pre-loaded with proteins or nucleic acids or cells or organic reagents.

24. The apparatus according to claim 17, wherein said input ports are pre-loaded with molecules in a lyophilised or dehydrated state.

25. An apparatus for performing an assay comprising:
at least one microfluidic tile said at least one microfluidic tile having at least one input port in fluid communication with at least one fluidic circuit;
a plurality of said microfluidic files forming an assembly of said tiles wherein said assembly forms a unitary surface having a plurality of input ports said plurality of input port forming a standard laboratory interface; and
a de-assembly means to separate the tiles from the assembly for use in a processing means.

26. The apparatus according to claim 25, wherein said at least one input port is located on a small face of the microfluidic tile.

27. The apparatus according to claim 25, where said processing means is selected from the group consisting of centripetal rotors and micro plate readers.

28. The apparatus according to claim 25, wherein said assembly and de-assembly means is selected from the group consisting of pins, enclosures, slits, slots, locks, covers, snap-in elements, spacers, lego-like connectors, elastic means, adhesive layers, magnetic means, suction.

29. The apparatus according to claim 25, where said standard laboratory interface is selected from the group consisting of 96, 384, 1536 micro plate standard interfaces or to a subset of their specifications.

30. A method of performing an assay comprising the steps of:
providing at least one microfluidic tile said at least one microfluidic tile having at least one input port in fluid communication with at least one fluidic circuit;
assembling a plurality of said microfluidic tiles forming an assembly of said tiles wherein said assembly forms a surface having a plurality of input ports having a standard laboratory interface;
inserting a sample into at least one input port;
de-assembling said assembly of said tiles into individual tiles; and
placing said individual tiles into a processing means.

31. The method according to claim 30 wherein said processing means is a centripetal rotor apparatus.

32. The method according to claim 31 wherein said input port is proximal to the rotation axis of said centripetal rotor apparatus.

33. The method according to claim 30, wherein said input port containing the selected sample is sealed after sample insertion.

34. The method according to claim 30 wherein inserting a selected sample is accomplished by standard fluid handling robotic systems.

35. The method according to claim 30 wherein said standard laboratory interface is equivalent to a 96, 384 or 1536 micro-plate.

36. The method according to claim 30 wherein said at least one fluidic circuit is in fluid communication with at least one detection chamber said detection chamber having means for detecting an analyte of interest.

37. The method according to claim 30, wherein said assay is selected from the group consisting of compound profiling, protein crystal formation, enzymatic biochemical assays, cellular assays, body fluid tests for diagnostics purposes.

38. The method according to claim 36, wherein said detection chamber contains a reagent specific to an analyte of interest.

39. The method according to claim 30, wherein said at least one input port is in fluid communication with a plurality of fluidic circuits.

40. The method according to claim 39, wherein said plurality of fluidic circuits can perform multiple assays in parallel upon a singular sample.

41. The method according to claim 39, wherein said plurality of fluidic circuits can perform the same assay in parallel upon a plurality of samples.

42. A method of forming a microfluidic tile comprising the steps of:
moulding a first substrate having a first and second planar surface having at least one depression on at least one of said first and second planar surface and a first fluidic circuit on the same surface
moulding a second substrate having a first and second planar surface and a second fluidic circuit herein; and
bonding said first and second substrate forming a microfluidic tile where said depression forms at least one input port within said microfluidic tile said microfluidic tile having a top and bottom planar surface and an input edge said input edge having at least one input port in fluid communication with said fluidic circuit.

43. The method according to claim 42, wherein the input port is in fluidic communication with said first fluidic circuit by means of the second fluidic circuit.

44. An apparatus for performing an assay comprising:
a microfluidic tile comprising a first and a second substrates being simply connected and bonded together;
at least one input port; and
at least one fluidic handling component between said first and second substrates of said tile, said at least one fluidic handling component being in fluid communication with said at least one input port;

45. The apparatus according to claim 44 being manufactured with a method selected from the group consisting of hot embossing, injection moulding, laser ablation, lamination, chemical etching.

46. The apparatus according to claim 44 further comprising a film layer bonded between the top and bottom substrates.

47. A method for forming a tile comprising:
bonding a first simply connected substrate and a second simply connected substrate forming at least one input port; and
forming at least one fluidic handling component between said first and second substrates of said tile, said at least one fluidic handling component being in fluid communication with said at least one input port.

48. An apparatus for performing an assay comprising:
a first and second tile bonded together to form a microfluidic tile;
at least one input port positioned on a small face of said microfluidic tile;
at least one fluidic handling component between said first and second tiles, said at least one fluidic handling component being in fluid communication with said at least one input port; and
means for affixing said microfluidic tile to additional microfluidic tiles.

49. The apparatus according to claim 48, further comprising a film between said first and second tile.

50. A method for forming a tile comprising:
Bonding a first and second tile with a film in between to form a microfluidic tile, said microfluidic tile comprising at least one input port positioned on a small face of said microfluidic tile and at least one fluidic handling component between said first and second tiles, said at least one fluidic handling component being in fluid communication with said at least one input port.

51. The method according to claim 49 wherein said at least one fluidic handling component comprises channels in fluid communication with at least one chamber said chamber having means for detecting an analyte of interest.

52. The apparatus according to claim 7 wherein said identification means are selected from the group consisting of optical identification, mechanical identification, physical identification, electrical identification, magnetic identification and radio identification.

53. The apparatus according to claim 16, wherein said input ports are pre-loaded with molecules in a frozen state.

54. The apparatus according to claim 24, wherein said tiles are separated from the assembly by bottom extraction.

55. The method according to claim 29, wherein extracting said tiles from the assembly is performed at the bottom of the assembly.
